(19) United States
(12) Patent Application Publication
(10) Pub. No.: US 2016/0196534 A1
(43) Pub. Date: Jul. 7, 2016

(54) TRAINING, TRACKING, AND PLACEMENT SYSTEM

(71) Applicant: Koru Careers, Inc., Seattle, WA (US)

(72) Inventors: Joshua Ryan Jarrett, Seattle, WA (US); Kristen Mary Hamilton, Seattle, WA (US); Justin Beals, Atlanta, GA (US); Anne Hanson, Seattle, WA (US)

(21) Appl. No.: 14/827,621

(22) Filed: Aug. 17, 2015

Related U.S. Application Data
(60) Provisional application No. 62/100,409, filed on Jan. 6, 2015.

(51) Int. Cl. G06Q 10/10; G06Q 50/20

(52) U.S. Cl. CPC G06Q 10/1053; G06Q 50/2057

(57) ABSTRACT

A training, tracking, and placement system determines a competence score for a job seeker with respect to a skill set and matches the job seeker with recruiters and/or employers based on the competence score. Competence scores of job seekers may be compared with thresholds provided by recruiters and/or employers to recommend training activities that may improve job seekers' skills in the skill set. Moreover, the training, tracking, and placement system can compare data associated with job seekers with predetermined criteria provided by recruiters and/or employers. Recruiters and/or employers can define predetermined criteria for various industry sectors, roles, and/or employment opportunities and search for and/or receive matches of job seekers who fulfill the specified criteria. The predetermined criteria may include a suitable competence score that a job seeker should have for the job, enabling the competence score to be used to match the job seeker with recruiters, employers, and/or employment opportunities.

### PRIORITY

This application claims priority to U.S. Provisional Application Ser. No. 62/100,409, which was filed Jan. 6, 2015, entitled “Learning Management System,” which is hereby incorporated by reference in its entirety.

### BACKGROUND

Many students graduate from college and find themselves alongside thousands of other college graduates looking for employment. Similarly, various individuals lose a job or relocate and end up in the same pool of individuals looking for employment. These job seekers have acquired some skills through life and others through their college and/or work experiences; but often times, many of the job seekers are lacking, or are deficient in, skills that are necessary for success in the industry sector for which they are otherwise qualified and/or interested. Additionally, recruiters, employers, and other individuals and/or businesses looking for job seekers may lack tools that are necessary to efficiently and effectively find qualified job seekers from small colleges or job seekers who have developed skill sets that replace or supplement standard means of measuring success (e.g., “college pedigree,” grades, etc.) in an employment environment.

### DESCRIPTION OF FIGURES

The detailed description is described with reference to the accompanying figures. In the figures, the left-most digit(s) of a reference number identifies the figure in which the reference number first appears. The same reference numbers in different figures indicate similar or identical items.

FIG. 1 is an example operating environment for a training, tracking, and placement system.

FIG. 2 is an example user interface that may be presented by the training, tracking, and placement system that provides a job seeker with functionality to engage the training, tracking, and placement system.

FIG. 3 is an example user interface that may be presented by the training, tracking, and placement system to inform a job seeker of his or her competence score corresponding to a skill set.

FIG. 4 is an example user interface that may be presented by the training, tracking, and placement system to inform a job seeker of his or her competence score corresponding to a skill set in view of a target industry sector, role, and/or employer.

FIG. 5 is an example user interface that may be presented by the training, tracking, and placement system that provides the functionality to recommend one or more training activities to a job seeker.

FIG. 6 is an example user interface that may be presented by the training, tracking, and placement system that provides a job seeker with functionality to participate in one of the recommended training activities.

FIG. 7 is an example user interface that may be presented by the training, tracking, and placement system that provides a job seeker with functionality to participate in one of the recommended training activities.

FIG. 8 is an example user interface that may be presented by the training, tracking, and placement system when a job seeker completes a training activity.

FIG. 9 is an example user interface that may be presented by the training, tracking, and placement system that provides a job seeker with functionality to elect to complete a training activity.

FIG. 10 is an example user interface that may be presented by the training, tracking, and placement system that provides a job seeker with functionality to begin a training activity.

FIG. 11 is an example user interface that may be presented by the training, tracking, and placement system that provides a job seeker with functionality to work on a training activity.

FIG. 12 is an example user interface that may be presented by the training, tracking, and placement system that provides a job seeker with functionality to view one or more interview invitations.

FIG. 13 is another example user interface that may be presented by the training, tracking, and placement system that provides a job seeker with functionality to accept one or more interviews.

FIG. 14 is an example user interface that may be presented by the training, tracking, and placement system that provides a job seeker with functionality to schedule an interview between the job seeker and a recruiter and/or employer.

FIG. 15 is an example user interface that may be presented by the training, tracking, and placement system that provides a recruiter and/or employer with functionality to input predetermined criteria for a particular employment opportunity, role, and/or industry sector.

FIG. 16 is an example user interface that may be presented by the training, tracking, and placement system that provides functionality to present and summarize information related to candidate job seekers.

FIG. 17 is an example user interface that may be presented by the training, tracking, and placement system that provides functionality to present additional information about a matched candidate job seeker.

FIG. 18 illustrates an example process for determining a job seeker's competence score with respect to a skill set and recommending one or more training activities to the job seeker.

FIG. 19 illustrates an example process for leveraging a determined competence score of a job seeker for matching the job seeker to one or more recruiters, employers, and/or employment opportunities.

FIG. 20 illustrates an example operating environment for a training, tracking, and placement system illustrating additional details of the training, tracking, and placement system of FIG. 1.

FIG. 21 illustrates an example user interface personalized for a job seeker to provide the job seeker with functionality to access diagnostic assessments, upload a resume, and/or otherwise interact with the training, tracking, and placement system.

FIG. 22 is another example user interface personalized for recruiters and/or employers that may be caused to be presented by the presentation module to provide recruiters and/or employers the functionality to input predetermined criteria and additional criteria for a particular employment opportunity, role, and/or industry sector.

FIG. 23 illustrates an example user interface personalized for a job seeker to communicate information associated with the competency of the job seeker to various users.

FIG. 24 illustrates an example process for determining a job seeker's competency with respect to his or her performance of individual skills of a skill set and recommending one or more training activities to the job seeker.

FIG. 25 describes an example process for comparing the job seeker's competence score(s) with threshold score(s) associated with an employer or employment opportunity.

FIG. 26 illustrates an example process for leveraging a job seeker's determined competence score(s) for determining whether to offer the job seeker an interview for an employment opportunity.

FIG. 27 illustrates a user interface that provides functionality for a job seeker to begin an application for one or more employment opportunities.

FIG. 28 illustrates an example of a user interface that may be presented to a job seeker notifying the job seeker that he or she has been invited to a pre-interview.

FIG. 29 illustrates a user interface configured to provide functionality for the job seeker to access and/or generate a video introduction, writing sample explaining why the job seeker is a good fit for the employment opportunity, recruiter, and/or employer, what the job seeker is most passionate about, etc.

FIG. 30 illustrates an example user interface that may be presented to universities or other educational institutions to provide functionality for the universities or other educational institutions to view graphical representations of aggregated data associated with job seekers who are associated with the universities or other educational institutions.

### DETAILED DESCRIPTION

A system for training, tracking, and placing job seekers in employment opportunities based on determining a competence score for a job seeker with respect to a skill set is described herein. The training, tracking, and placement system may include one or more engines utilized by a plurality of users such as job seekers, recruiters, universities or other educational institutions, parents, etc. The techniques described herein provide various examples of generating personalized user interfaces that provide various functionalities to summarize information associated with job seekers, employers, recruiters, universities or other educational institutions, parents, etc. and/or enable job seekers, employers, recruiters, universities or other educational institutions, parents, etc. to interact with one another and/or the training, tracking, and placing system.

In at least one example, the system for training, tracking, and placing job seekers in employment opportunities based on determining a competence score for a job seeker with respect to a skill set and matching the job seeker with one or more recruiters and/or employers based on the competence score is described herein. The techniques described herein provide diagnostic assessments to determine a job seeker's competency with respect to performing individual skills in a skill set. For the purposes of this discussion, competency refers to a job seeker's aptitude, proficiency, expertise, and/or ability to perform one or more skills in the skill set, as described below. The techniques described herein enable job seekers to receive quantitative feedback on their competency with respect to the skill set via competence scores and compare their competence scores with other job seekers and/or threshold scores for specified industry sectors (e.g., job tracks), roles, and/or employment opportunities. Moreover, the techniques described herein include one or more diagnostic assessments to recommend industry sectors (e.g., job tracks), roles, employment opportunities, and/or employers to job seekers based in part on user preferences, personality traits, qualifications, etc.

For the purposes of this discussion, a skill set may include skills that are considered highly desirable in certain industries or companies, including but not limited to innovative, high growth industries and companies. The skills may correspond to facilities, talents, qualities, etc. that may be predictive of performance in certain industry and/or company settings. As a non-limiting example, the skill set may include skills such as grit (e.g., ability to act with tenacity, resiliency, etc. in work environments), rigor (e.g., ability to think analytically, in a data-driven manner, exhaustively, etc.), polish (e.g., ability to communicate professionally, confidently, authentically, etc.), impact (e.g., ability to prioritize time, actions, etc.), curiosity (e.g., ability to learn quickly, empathize with customers, think creatively, innovatively, etc.), teamwork (e.g., ability to work with others, etc.), ownership (e.g., ability to take initiative, etc.), etc. Each skill in the skill set may have one or more sub-skills that are hierarchically related to the skill. In at least one example, a competence score may be a total score representative of a job seeker's competency with respect to each skill of the skill set. The competence score may be determined based at least in part on a diagnostic assessment, data associated with the job seeker including data associated with demographics, education credentials, employment experiences, publications, associations, personal and/or professional interests, talents, hobbies, qualifications, preferences, etc., etc. In some examples, the competence score may be associated with a confidence score representing a level of confidence associated with the competence score. The level of confidence may be based on a familiarity of a service provider with a job seeker and/or a job seeker's level of interaction with the service provider, as described below.

Additionally, the system for training, tracking, and placing job seekers may receive and/or access postings associated with employment opportunities. In some examples, recruiters and/or employers may input the postings associated with employment opportunities into the system for training, tracking, and placing job seekers. Recruiters may include recruiting service providers, job posting service providers (e.g., Monster®, LinkedIn®, etc.) and/or any other type of entity recruiting job seekers ultimately for employment opportunities. In at least one example, the recruiters and/or employers may input data associated with the employment opportunities and/or various industry sectors (e.g., job tracks) and/or roles, such as predetermined criteria corresponding to the competency of the job seeker (e.g., competence score(s)) of a job seeker), location of the job seeker, citizenship of the job seeker, evidence of work product associated with the job seeker, etc. The techniques described herein enable recruiters and/or employers to search for and/or determine job seekers who fulfill the predetermined criteria. The techniques described herein enable recruiters and/or employers to easily identify qualified job seekers using data rich summaries associated with job seekers that include the competence score described above. Additionally, the techniques described herein enable recruiters and/or employers to search for and filter through job seekers based at least in part on the competence scores.

For purposes of this discussion, industry sectors may include various areas of expertise associated with innovative, high growth companies. For instance, non-limiting examples of industry sectors may include a business, finance, and data analytics sector, a human resources sector, project management and operations sector, etc. Roles may include specific jobs associated with an industry sector. For instance, non-limiting examples of roles associated with a copywriting and social media industry sector may include a social media and branding manager, a social media public relations coordinator, a social media content strategist, etc. Non-limiting examples of roles associated with a human resources industry sector may include a recruiter, a staffing manager, a payroll specialist, etc. Employment opportunities may include roles for which an employer has a current need to fill (e.g., roles for which an employer is currently hiring).

Additionally and/or alternatively, the recruiters and/or employers may leverage the training, tracking, and placement system to track applicants (e.g., job seekers who have applied for employment opportunities posted by the recruiters and/or employers). For instance, the recruiters and/or employers may leverage data analytics output by the training, tracking, and placement system to determine a number of job seekers who applied for a specific employment opportunity, progress of the applicants with respect to the application process, a number of interviews extended, etc.

Techniques for comparing predetermined criteria provided by recruiters and/or employers to user information associated with job seekers via the training, tracking, and placement system are also described. In additional and/or alternative examples, the training, tracking, and placement system described herein may enable job seekers to access the postings associated with employment opportunities associated with one or more recruiters and/or employers and apply for the employment opportunities. The training, tracking, and placement system may compare the competency (e.g., competence score(s)) of a job seeker with the predetermined criteria provided by one or more recruiters and/or employers to recommend and/or provide training activities (e.g., training programs, exercises, and/or projects) that may improve one or more of the job seeker's skills in the skill set. Moreover, the training, tracking, and placement system described herein may leverage a competence score associated with job seekers to match the job seekers with one or more recruiters, employers, and/or employment opportunities and may facilitate scheduling interviews between the job seekers and one or more recruiters, employers, and/or employment opportunities.

Universities or other educational institutions and/or parents and/or guardians may also utilize the training, tracking, and placement system to determine where job seekers are applying (e.g., by region, by city, by employer, by industry sector, etc.), progress of the job seekers with respect to the application process, a number of interviews offered to the job seekers, etc. Additionally and/or alternatively, universities or other educational institutions may also utilize aggregated data collected by the training, tracking, and placement system to determine strengths and/or weaknesses with respect to course offerings, extracurricular offerings, programming, etc. and/or determine activities for improving competence scores of their students, etc. Similarly, parents and guardians may also utilize data collected by the training, tracking, and placement system to determine strengths and/or weaknesses of their children (e.g., the job seekers) for tracking progress of their children, offer advice on their child's job search, recommend one or more training activities for their children, etc.

The techniques described herein leverage data collection via one or more devices, as described below, to increase efficiencies in hiring and recruiting practices, reduce costs, improve access to qualified talent, and lead to higher retention rates in employment environments. In at least some examples, the techniques described herein may be integrated into other platforms, including social media platforms such as LinkedIn®, Monster®, Facebook®, etc. In at least one example, users may integrate their competence scores, electronic portfolios (“e-portfolios”), and other data into accounts associated with each of the social media platforms and/or the systems described below may access information associated with accounts associated with the social media platforms.

### Illustrative Environments

The environments described below constitute examples and are not intended to limit application of the system described below to any one particular operating environment. Other environments may be used without departing from the spirit and scope of the claimed subject matter. The various types of processing described herein may be implemented in any number of environments including, but not limited to, stand alone computing systems, network environments (e.g., local area networks or wide area networks), peer-to-peer network environments, distributed-computing (e.g., cloud-computing) environments, etc.

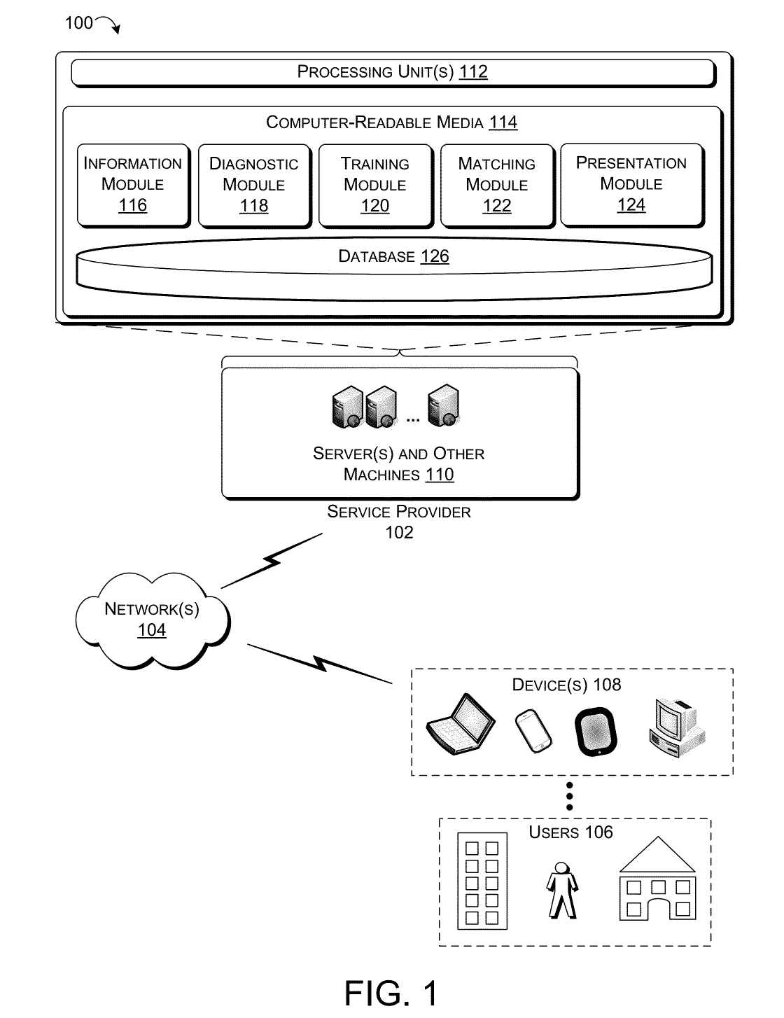

FIG. 1 illustrates an example operating environment 100 that includes a variety of devices and components that may be implemented in a variety of environments for a training, tracking, and placement system. The example operating environment 100 may include a service provider 102, one or more network(s) 104, one or more users 106, and one or more devices 108 associated with the one or more users 106. The techniques described herein may be performed on a single device or across multiple devices.

As shown, the service provider 102 may include one or more server(s) and other machines 110, any of which may include one or more processing unit(s) 112 and computer-readable media 114. The service provider 102 may be implemented in a non-distributed computing environment or may be implemented in a distributed computing environment, possibly by running some modules on devices 108 or other remotely located devices. In various embodiments, the service provider 102 may perform diagnostic assessments to determine competence scores associated with job seekers (e.g., users 106) that represent the job seekers' performances of individual skills in a skill set and recommend and provide training programs, exercises, and/or projects to improve the job seekers' competence scores. The service provider 102 may leverage data associated with the skill set for matching recruiters and/or employers (e.g., users 106) and job seekers and/or specific employment opportunities with one or more of the job seekers. Additionally, the service provider 102 may receive data from one or more job seekers and leverage the data for recommending industry sectors (e.g., job tracks), roles, employment opportunities, recruiters, and/or employers. Moreover, the service provider 102 may generate personalized user interfaces that provide various functionalities to summarize information associated with job seekers, employers, recruiters, universities or other educational institutions, parents, etc. and/or enable job seekers, employers, recruiters, universities or other educational institutions, parents, etc. to interact with one another and/or the service provider 102.

In some embodiments, the network(s) 104 may be any type of network known in the art, such as the Internet. Moreover, the users 106 may communicatively couple to the network(s) 104 in any manner, such as by a global or local wired or wireless connection (e.g., local area network (LAN), intranet, etc.). The network(s) 104 may facilitate communication between the server(s) 110 and the devices 108 associated with the users 106.

For purposes of this discussion, the users 106 may include persons, entities, etc. Persons may include students, parents, employers, employees, job seekers, recruiters, etc. As described above, the techniques described herein enable job seekers to receive quantitative feedback and/or training with respect to a skill set. Additionally, the techniques described herein may use competence scores to match job seekers with recruiters, roles, and/or employment opportunities. The techniques described herein enable recruiters and/or employers to easily search for and filter through job seekers using data rich summaries associated with the job seekers, track applicants, etc. Additionally, parents and/or guardians may leverage the systems described herein to track progress of their children (e.g., job seekers), offer advice on their child's job search, recommend one or more training activities for their children, etc.

Entities may include universities, businesses, other members of professional environments and/or settings, advertisers and affiliates, third-party content providers, etc. In at least one example, universities may leverage the techniques herein to collect and analyze data associated with students of the universities (e.g., job seekers). In some examples, universities may use the data collection as described below as an aggregate reporting tool to indicate how individual students are performing on the diagnostic assessments and/or determine what companies are hiring individual students. In other examples, universities may use the data collection as an independent support tool to determine particular support or curriculum (e.g., classes, experiences, etc.) that it may offer and/or recommend for improving competence scores associated with individual students of the university. Advertisers and affiliates may leverage the systems described herein to push advertisements to users 106 and third-party content providers may leverage the systems described herein to provide content to the training, tracking, and placement system for diagnostic assessments, training activities, etc.

In some embodiments, the users 106 may operate corresponding devices 108 to perform various functions associated with the devices 108. Device(s) 108 can represent a diverse variety of device types and are not limited to any particular type of device. Examples of device(s) 108 can include but are not limited to stationary computers, mobile computers, embedded computers, or combinations thereof. Example stationary computers can include desktop computers, work stations, personal computers, thin clients, terminals, game consoles, personal video recorders (PVRs), set-top boxes, or the like. Example mobile computers can include laptop computers, tablet computers, wearable computers, implanted computing devices, telecommunication devices, automotive computers, personal data assistants (PDAs), portable gaming devices, media players, cameras, or the like. Example embedded computers can include network enabled televisions, integrated components for inclusion in a computing device, appliances, microcontrollers, digital signal processors, or any other sort of processing device, or the like.

Moreover, and as shown, the service provider 102 may include one or more server(s) and other machines 110, which may include one or more processing unit(s) 112 and computer-readable media 114, such as memory. The one or more server(s) and other machines 110 may include devices. Examples support scenarios where device(s) that may be included in the one or more server(s) and other machines 110 can include one or more computing devices that operate in a cluster or other grouped configuration to share resources, balance load, increase performance, provide fail-over support or redundancy, or for other purposes. Device(s) included in the one or more server(s) and other machines 110 can belong to a variety of categories or classes of devices such as traditional server-type devices, desktop computer-type devices, mobile devices, special purpose-type devices, embedded-type devices, and/or wearable-type devices. Thus, although illustrated as desktop computers, device(s) can include a diverse variety of device types and are not limited to a particular type of device. Device(s) included in the one or more server(s) and other machines 110 can represent, but are not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device.

Device(s) that may be included in the one or more server(s) and other machines 110 and/or device(s) 108 can include any type of computing device having one or more processing unit(s) 112 operably connected to computer-readable media 114 such as via a bus, which in some instances can include one or more of a system bus, a data bus, an address bus, a PCI bus, a Mini-PCI bus, and any variety of local, peripheral, and/or independent buses. Executable instructions stored on computer-readable media 114 can include, for example, the information module 116, the diagnostic module 118, the training module 120, the matching module 122, the presentation module 124, and other modules, programs, or applications that are loadable and executable by processing units(s) 112. Alternatively, or in addition, the functionally described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator can represent a hybrid device, such as one from ZYLEX or ALTERA that includes a CPU course embedded in an FPGA fabric.

Device(s) that may be included in the one or more server(s) and other machines 110 and/or devices 108 can further include one or more input/output (I/O) interface(s) coupled to the bus to allow device(s) to communicate with other devices such as user input peripheral devices (e.g., a keyboard, a mouse, a pen, a game controller, a voice input device, a touch input device, gestural input device, and the like) and/or output peripheral devices (e.g., a display (e.g., display), a printer, audio speakers, a haptic output, and the like). Devices that may be included in the one or more server(s) and other machines 110 can also include one or more network interfaces coupled to the bus to enable communications between computing devices and other networked devices such as device(s) 108. Such network interface(s) can include one or more network interface controllers (NICs) or other types of transceiver devices to send and receive communications over a network. For simplicity, some components are omitted from the illustrated device.

Processing unit(s) 112 can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-chip systems (SOCs), Complex Programmable Logic Devices (CPLDs), etc. In various embodiments, the processing unit(s) 112 may execute one or more modules and/or processes to cause the server(s) and other machines 110 to perform a variety of functions, as set forth above and explained in further detail in the following disclosure. Additionally, each of the processing unit(s) 112 may possess its own local memory, which also may store program modules, program data, and/or one or more operating systems.

In at least one configuration, the computer-readable media 114 of the server(s) may include components that facilitate interaction between the service provider 102 and the users 106. For example, the computer-readable media 114 may include an information module 116, diagnostic module 118, training module 120, matching module 122, presentation module 124, and/or other modules. The information module 116, diagnostic module 118, training module 120, matching module 122, and presentation module 124, and/or other modules can be implemented as computer-readable instructions, various data structures, and so forth via at least one processing unit(s) 112 to configure a device to execute instructions and to perform operations described herein.

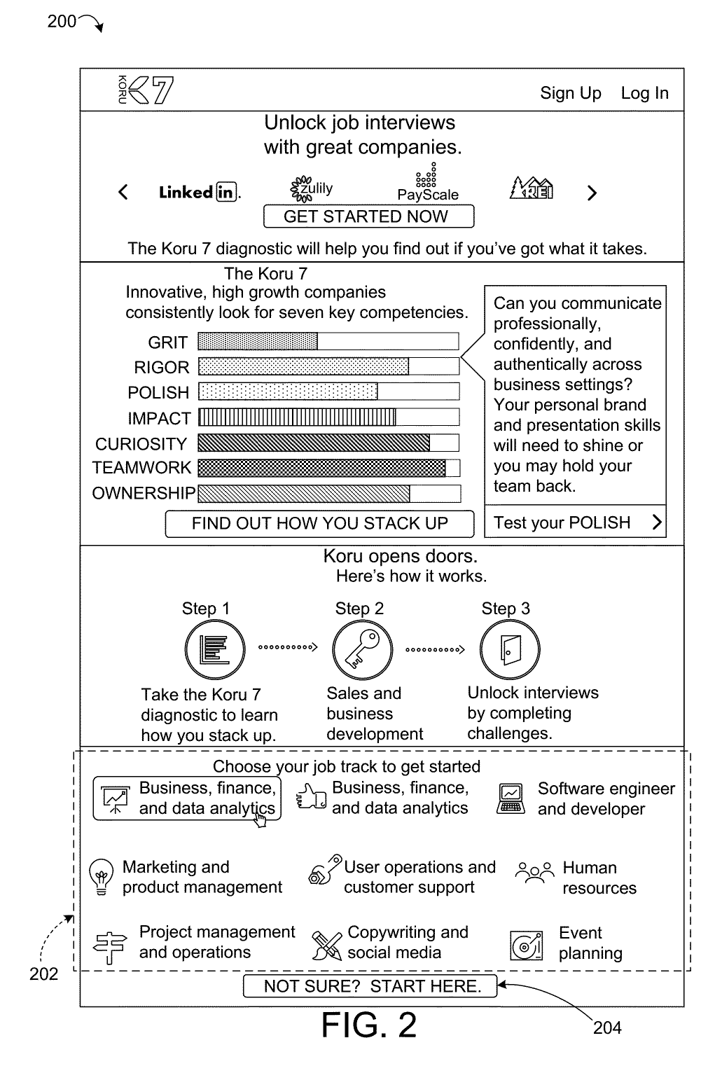

For instance, in at least one example, the information module 116 may receive, access, and/or store data associated with the users 106 (e.g., job seekers, employers, recruiters, etc.). Furthermore, in the at least one example, the diagnostic module 118 may generate, store, and/or provide diagnostic assessments for completion by the job seekers and may determine a job seeker's competence score representing a competency of the job seeker with respect to performing individual skills in a skill set, compatibility (e.g., fitness) with respect to particular employers, and/or interest specific to industry sectors (e.g., job tracks) and/or roles. The training module 120 may identify one or more training activities, such as training programs, exercises, and/or projects that may improve one or more skills in the skill set and accordingly, improve the job seeker's competence score. The training module 120 may recommend and facilitate the training activities. The matching module 122 may leverage determined competence scores, compatibility with respect to particular companies, interest specific to industry sectors and/or roles, and other relevant information to match two or more users 106 (e.g., job seekers and recruiters and/or employers) and/or recommend one or more employment opportunities to job seekers. The presentation module 124 may generate and/or cause to be presented one or more user interfaces that provide various functionalities to summarize information associated with job seekers, employers, recruiters, universities or other educational institutions, parents and/or guardians, etc. and/or enable job seekers, employers, recruiters, universities or other educational institutions, parents and/or guardians, etc. to interact with one another and/or the service provider 102. Various, non-limiting examples of graphical user interfaces are shown in FIGS. 2-17, 21-23, and 27-30. The graphical user interfaces enable job seekers to more efficiently find employment opportunities and/or employers and/or recruiters and/or employers to more efficiently find qualified employees (e.g., job seekers).

In addition to the information module 116, the diagnostic module 118, training module 120, the matching module 122, and the presentation module 124, the computer-readable media 114 of the server(s) may include a database 126. In at least one example, the database 126 may store at least some data associated with the users 106 (e.g., job seekers, employers, recruiters, etc.), diagnostic assessments for completion by the job seekers, etc. Additionally and/or alternatively, the database 126 may include a document style database (e.g., XML, etc.), a graph database, and/or an ontological map. The document style database, the graph database, and the ontological map store data associated with users 106 and/or experiences of users 106 based at least in part on relating the data associated with the users 106 and/or experiences of the users 106 and determining relationships between the related data and/or users 106. In at least one example, machine learning algorithms (e.g., supervised learning algorithms, unsupervised learning algorithms, deep learning algorithms, etc.) may access the document style database, the graph database, and the ontological map for learning new machine learning algorithms for inferring relationships between new data associated with the users 106 and/or experience associated with the users 106 and the users 106.

Depending on the exact configuration and type of the one or more server(s) and other machines 110, the computer-readable media 114 may include computer storage media and/or communication media. Computer storage media can include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast, communication media may embody computer readable instructions, data structures, program modules, or other data in a modulated data signal, such as a carrier wave, or other transmission mechanism. The term “modulated data signal” means a signal that has one or more of its characteristics set or changed in such a manner as to encode information in the signal. Such signals or carrier waves, etc. can be propagated on wired media such as a wired network or direct-wired connection, and/or wireless media such as acoustic, RF, infrared and other wireless media. As defined herein, computer storage media does not include communication media. That is, computer storage media does not include communications media consisting solely of a modulated data signal, a carrier wave, or a propagated signal, per se.

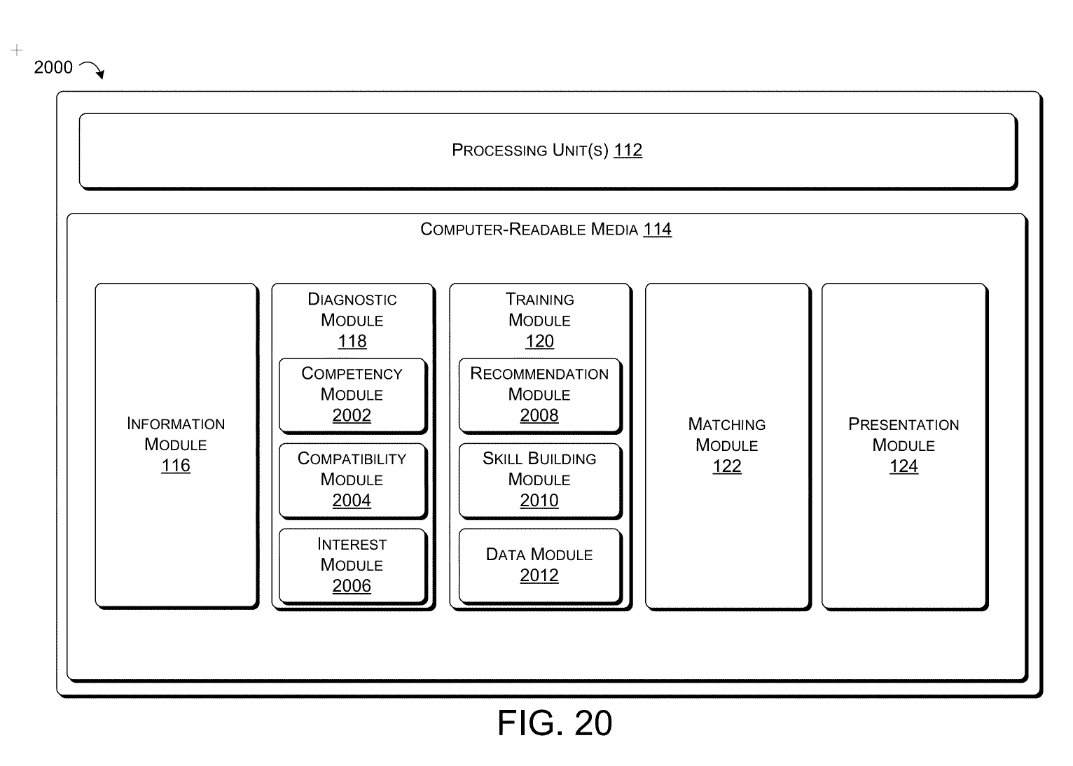

FIG. 20 illustrates an example operating environment 2000 for a training, tracking, and placement system illustrating additional details of the training, tracking, and placement system of FIG. 1.

As described above, in at least one example, the information module 116 may receive, access, and/or store data associated with the users 106 (e.g., job seekers, recruiters, universities or other academic institutions, parents and/or guardians, etc.). The data may be associated with information about the users 106. In at least one example, information may be input by users 106 via an application programming interface associated with the service provider 102. In some examples, users 106 may input information into the information module 116 by creating a profile (e.g., user profile) that corresponds to an account associated with the service provider 102. The user profile may be associated with a unique identifier for identifying the user profile in the information module 116 and mapping data to the user profile.

For job seekers, the user profile may include data associated with demographics, education credentials, employment experiences, publications, associations, personal and/or professional interests, talents, hobbies, qualifications, preferences, etc. In at least one example, job seekers may input the information via an application programming interface associated with the service provider 102. The application programming interface, via the presentation module 124, may cause a user interface to be presented to the job seeker via a display of the device 108. The user interface may provide functionality for the job seeker to input his or her information. In some examples, job seekers may input information responsive to diagnostic assessments described below. In other examples, job seekers may upload resumes and/or other data items into the training, tracking, and placement system and the information module 116 may extract data from the resumes and/or other data items. In additional or alternative examples, the information module 116 may also access and/or retrieve information from social media accounts (e.g., LinkedIn®, Facebook®, etc.), retail purchase accounts (e.g., Amazon®, Nordstrom®, etc.), online banking accounts, geolocation devices, etc., associated with the job seekers. In some examples, the information module 116 may store a combination of data input by the job seeker and accessed and/or retrieved data associated with the job seekers in the profile corresponding to the job seeker. In alternative or additional examples, the information module 116 may send data to the database 126, cloud storage, and/or another data repository.

In the examples where the information is private or includes personally identifiable information (PII) that identifies or can be used to identify, contact, or locate a person and/or entity to which such data pertains, a user 106 may be provided with notice that the systems and methods herein are collecting PII. Additionally, prior to initiating PII data collection, users 106 may have an activity to opt-in or opt-out of the PII data collection. For example, a user 106 may opt-in to the PII data collection by taking affirmative action indicating that he or she consents to the PII data collection. Alternatively, a user 106 may be presented with an option to opt-out of the PII data collection. An opt-out option may require an affirmative action to opt-out of the PII data collection, and in the absence of affirmative user action to opt-out, PII data collection may be impliedly permitted.

For recruiters and/or employers, the user profile may include data associated with employment opportunities, roles, and/or industry sectors relevant to the particular recruiter and/or employer, predetermined criteria for employment opportunities, roles, and/or industry sectors, information about and/or preferences of the particular recruiter and/or employer (e.g., location of headquarters, location of offices, company history, company philosophy, company culture, details of employment opportunities, etc.). In at least one example, recruiters and/or employers may input the data into the information module 116 via an application programming interface associated with the service provider 102. The application programming interface, via the presentation module 124, may cause a user interface to be presented to the recruiter and/or employer via a display of a device 108. The user interface may provide functionality for the recruiters and/or employers to input data. The recruiters and/or employers may input information when the recruiters and/or employers set up a user profile, when the recruiters and/or employers complete an order (e.g., a submission for a posting), or at a later time.

The recruiter and/or employer may input data that may include predetermined criteria such as a threshold score and/or individual threshold scores for one or more of the individual skills in the skill set that a job seeker should achieve to be considered by the recruiter and/or employer or for a particular role. In at least one example, the predetermined criteria may be based on diagnostic assessments completed by employees of the employer. For instance, employers may leverage the training, tracking, and placement system to determine competence scores for current employees and may leverage the competence scores for the current employees to determine the threshold score and/or individual threshold scores, required skills, preferred skills, etc. In at least one example, determined competence scores for current employees may be associated with industry sectors, roles, employment opportunities, etc. In some examples, employers may leverage the training, tracking, and placement system to determine competence scores for current employees and may leverage the competence scores for the current employees to determine the threshold score and/or individual threshold scores that are the same as average competence scores and/or scores associated with the individual skills associated with current employees and/or required skills, preferred skills, etc. that correspond to skills of which the current employees collectively exhibit strength. In other examples, employers may leverage the training, tracking, and placement system to determine competence scores for current employees and may leverage the competence scores for the current employees to determine the threshold score and/or individual threshold scores that are the different from average competence scores and/or scores associated with the individual skills associated with current employees and/or required skills, preferred skills, etc. that are different from skills that the current employees collectively have strength in. That is, employers can use the training, tracking, and placement system to find new employees with same competencies and/or skills with respect to the skill set and/or new employees that have different competencies and/or skills with respect to the skill set to supplement and/or diversify their employees.

Additionally and/or alternatively, the recruiters and/or employers may input data associated with predetermined criteria that may indicate which of the skills in the skill set are required or preferred for job seekers to qualify for a pre-interview, interview, etc. associated with an employment opportunity. The recruiters and/or employers may also input additional criteria for a particular industry sector, role, and/or employment opportunity. As non-limiting examples, the recruiters and/or employers may input additional criteria such as schedule flexibility, relocation allowances, evidence requirements (associated with a pre-interview, etc.), citizenship requirements, etc. that are preferred or required for an employment opportunity.

The recruiters and/or employers may input data associated with a particular industry sector, role, and/or employment opportunity. In a non-limiting example, a recruiter and/or employer may input data about the recruiter and/or employer, a description of the industry sector, role, and/or employment opportunity, responsibilities and skills associated with the industry sector, role, and/or employment opportunity. Furthermore, the recruiters and/or employers may input descriptions of work spaces for determining whether a job seeker is compatible with a particular employer. In at least some examples, the information module 116 may also access and/or retrieve information from social media accounts, retail purchase accounts, online banking accounts, geolocation devices, etc., associated with the recruiters and/or employers. In some examples, the information module 116 may store a combination of data input by the recruiter and/or employer and accessed and/or retrieved data associated with the recruiters and/or employers. In alternative or additional examples, the information module 116 may send data to the database 126, cloud storage, and/or another data repository.

With respect to a specific employment opportunity, recruiters and/or employers may input data associated with the recruiter and/or employer, a description of the specific employment opportunity, responsibilities and skills associated with the particular specific activity. Moreover, the recruiters and/or employers may input data associated with a predetermined number of job seekers the recruiters and/or employers want to interview and/or review for the particular employment opportunity, a start date associated with a posting for the particular employment opportunity, an end date associated with the posting for the particular employment opportunity, etc.

The information module 116 may also receive, access, and/or store data associated with diagnostic assessments, training activities, and other sources as described below. In at least one example, the information module 116 may receive, access, and/or store data associated with competence scores representative of job seekers' competencies with respect to performing the skills in the skill set and other information for comparing and/or matching one or more of the users 106 (e.g., job seekers and/or recruiters and/or employers). In additional or alternative examples, the information module 116 may receive, access, and/or store compatibility data that may be leveraged to recommend employers to job seekers, or interest data that may be leveraged to recommend particular industry sectors, roles, and/or employment opportunities to job seekers. In each of the examples above, the data associated with the competence scores, compatibility data, and/or interest data may be mapped to user profiles corresponding to individual job seekers. Additionally or alternatively, at least some of the data associated with diagnostic assessments, training activities, competence scores, compatibility data, interest data, etc. may be stored in the database 126, cloud storage, and/or some other data repository.

As job seekers complete, or in some circumstances, repeat one or more assessments, training activities, etc., the information module 116 and/or database 126 may receive updated data associated with competence scores for storing. The updated data may be mapped to the user profiles corresponding to individual job seekers. The information module 116 and/or database 126 may also store an electronic portfolio associated with a job seeker. The electronic portfolio may include a plurality of data items generated by the job seeker. In at least one example, the electronic portfolio may include work product (e.g., from completed training activities), videos of presentations, documents associated with completed activities and/or tasks, etc., as described below. The data items associated with the electronic portfolio may be mapped to the user profiles corresponding to individual job seekers. Recruiters may access the data items associated with the electronic portfolio to retrieve evidence of the competency of a job seeker with respect to the skill set described below.

The diagnostic module 118 may generate, access, store, and/or provide diagnostic assessments for completion by job seekers. The diagnostic module 118 may receive results in response to the job seekers completing the diagnostic assessments. The diagnostic module 118 may include additional modules such as a competency module 2002, compatibility module 2004, and/or interest module 2006.

In at least one example, the competency module 2002 may generate, receive, and/or access one or more diagnostic assessments to determine a job seeker's competency with respect to performing individual skills in the skill set. The competency module 2002 may prompt a job seeker with a plurality of questions to determine how the job seeker performs with respect to each of the skills in the skill set. The questions may include binary questions, situational judgment questions, Likert questions, fill-in-the-blank questions, etc. Each job seeker's competence score may be determined based at least in part on how the job seeker responds to the questions. In at least one example, a job seeker may be associated with a baseline score with respect to each skill in the skill set and a baseline competence score determined from the baseline scores each corresponding to a skill in the skill set. Based at least in part on a job seeker's answer, response, choice, etc., the competency module 2002 may positively or negatively adjust one or more baseline scores that each corresponds to a skill in the skill set. In an example, the competency module 2002 may utilize the document style database (e.g., XML, etc.), the graph database, and/or the ontological map associated with the database 126 to determine relationships between questions asked, job seeker responses, and individual skills in the skill set for positively or negatively adjusting one or more baseline scores that each corresponds to a skill in the skill set. The ontological map may identify relationships between questions asked, job seeker responses, and individual skills and/or specify a nature of association between the questions asked, job seeker responses, and individual skills in the ontological map. The positive and/or negative adjustments may be associated with different values indicating the relevance between the questions asked and the one or more skills in the skill set. The number of documents associated with the document style database may be scalable. Additionally or alternatively, the values associated with the positive and/or negative adjustments may change.

In a non-limiting example, a diagnostic assessment may include a situational judgment question that asks the job seeker what he or she would do if, knowing that the job seeker had a vacation planned, his or her boss asked him or her to delay his or her vacation to finish a project by a deadline. If the job seeker indicated that he or she would delay his or her vacation, the competency module 2002 may increase the baseline score associated with the skill grit by a predetermined value. If the job seeker indicated that he or she would tell his or her boss to pound sand, the competency module 2002 may decrease the baseline score associated with the skill grit. Additionally and/or alternatively, the competency module 2002 may increase or decrease one or more additional baseline scores each corresponding to a skill of the skill set. For instance, if the job seeker indicated that he or she would delay his or her vacation, the competency module 2002 may increase the baseline score associated with the skill teamwork by a predetermined value. The adjustments may be the same or different for individual skills in the skill set.

After completion of the diagnostic assessment, the diagnostic module 118 may output the competency of the job seeker in relation to the skill set as a competence score. In at least one example, the competence score may be a total score determined based at least in part on the job seeker's score with respect to each of the skills of the skill set. The presentation module 124 may generate user interfaces, as described below, to communicate information associated with the competency of the job seeker to various users 106.

Additionally or alternatively, the competence score may be determined based on additional data received, accessed, and/or stored in the information module 116 and/or database 126. For instance, in at least some examples, the competence score may be based at least in part on additional data such as data associated with the job seeker's resume (e.g., data corresponding to academic credentials, college experience, life experience, work experience, extracurricular activities, etc.), user profile, social media accounts, retail purchase accounts, online banking accounts, geolocation devices, etc., associated with the job seeker. In at least one example, a job seeker may be associated with a baseline score with respect to each skill in the skill set and a baseline competence score determined from the baseline scores each corresponding to a skill in the skill set, as described above. Based at least in part on data determined from the job seeker's resume, user profile, social media accounts, retail purchase accounts, online banking accounts, geolocation devices, etc., the competency module 2002 may positively or negatively adjust one or more baseline scores each corresponding to a skill in the skill set. The positive and/or negative adjustments may be associated with different values indicating the relevance between the data and the one or more skills in the skill set. In an example, the competency module 2002 may utilize the document style database (e.g., XML, etc.), the graph database, and/or the ontological map associated with the database 126 to determine relationships between data and individual skills in the skill set for positively or negatively adjusting one or more baseline scores each corresponding to a skill in the skill set. In this example, the ontological map may identify relationships between data associated with the job seekers and individual skills and/or specify a nature of association between the data associated with the job seekers and individual skills in the ontological map.

The competence score may be updated during or after the job seeker completes training activities. In at least some examples, the competence score may be updated based at least in part on increases to individual scores corresponding to the individual skills of the skill set. Based at least in part on receiving data indicating that a job seeker successfully completed one or more training activities, the competency module 2002 may positively adjust one or more baseline scores corresponding one or more skills in the skill set to which the one or more training activities pertained. The positive adjustments may be associated with different values indicating the relevance between the one or more training activities successfully completed and the one or more skills in the skill set. In an example, the competency module 2002 may utilize the document style database (e.g., XML, etc.), the graph database, and the ontological map to determine relationships between the one or more training activities and individual skills in the skill set for positively adjusting one or more baseline scores each corresponding to a skill in the skill set. In this example, the ontological map may identify relationships between one or more training activities and individual skills and/or specify a nature of association between the one or more training activities and individual skills in the ontological map.

The compatibility module 2004 may generate and/or access one or more diagnostic assessments to determine a job seeker's compatibility with respect to particular employers and/or the particular employers' work spaces. In at least some examples, the diagnostic module 118 may prompt a job seeker for input regarding an employer that he or she is interested in working for. The job seeker may provide an indication as to which employer(s) he or she is interested in working for. In an event the job seeker is unsure of which employer he or she is interested in working for, the compatibility module 2004 may provide an additional assessment for the job seeker to determine which employer best matches the job seeker's preferences and/or personality traits. In at least some examples, the job seeker may elect to participate in the compatibility assessment by actuating a control (e.g., 204 on user interface 200) or by providing some other indication that he or she would like to participate in the compatibility assessment to identify employers that may be of interest to the job seeker.

The compatibility module 2004 may ask the job seeker a plurality of questions to determine which employer best matches the job seeker's preferences based at least in part on the employer's description of its work space. The employer's description of its work space may be stored in the information module 116, the database 126, cloud storage, and/or other data repository. In at least one example, the compatibility assessment may comprise a series of questions with one or more drop-down answers from which the job seeker may select an answer that most appropriately describes the job seeker's preferences and/or personality traits. In additional or alternative examples, the compatibility assessment may include a series of questions associated with a decision tree, a plurality of work space characteristics that are presented to the job seeker for the job seeker to indicate his or her preferences, a plurality of work space characteristics with sliding scales for the job seeker to indicate a level of importance of each characteristic, etc. As a non-limiting example, a job seeker may indicate his or her preference for a social work space, a work space where people get dressed up, a work space in a particular geographic location, etc. Based at least in part on the job seeker's answers to the questions and/or selections, the compatibility module 2004 may recommend one or more employers that may be of interest to the job seeker. In some examples, the compatibility module 2004 may recommend employers based on employers who subscribe to the services provided by the service provider 102.

In at least one example, employers may provide data to the information module 116 that relates to and/or describes their work space. The employers may provide such data during the formation of their user profile or at a later time via a user interface caused to be presented by the presentation module 124. As non-limiting examples, employers may indicate that the work space is relaxed, the hours employees are expected to be in the office are flexible, appropriate work attire includes jeans and t-shirts, etc. In at least one example, the compatibility module 2004 may provide employers with a series of questions with one or more drop-down answers from which the employer may select an answer that most appropriately describes the employer's work space. In additional or alternative examples, the compatibility module 2004 may provide employers with a plurality of work space characteristics from which the employer may select one or more characteristics that appropriately describe the employer's work space, a plurality of work space characteristics with sliding scales for the employer to indicate a level of importance of each characteristic, etc. Data associated with the employer preferences may be stored in the information module 116, database 126, cloud storage, and/or other data repositories.

The interest module 2006 may generate and/or access one or more diagnostic assessments to determine a user's 106 interest specific to industry sectors and/or roles. In at least some examples, the diagnostic module 118 may prompt a job seeker for input regarding an intended industry sector or role. For example, as illustrated in FIG. 2, the presentation module 124 may present a job seeker with a user interface 200 that provides the job seeker with functionality to engage by taking diagnostic assessments associated with competency, interest, etc. Examples of the industry sectors or job tracks may include business, finance, and data analytics, sales and business development, software engineer and developer, marketing and product management, human resources, project management and operations, copywriting and social media, etc., as illustrated in box 202. The job seeker may provide an indication as to which industry sector and/or role he or she is interested in. In an event the job seeker is unsure of which industry sector and/or role he or she is interested in, the interest module 2006 may provide an additional assessment for the job seeker to determine which industry sector and/or role best matches the job seeker's preferences and/or qualifications. In at least some examples, the job seeker may elect to participate in the interest assessment by actuating a control 204 on the user interface 200 or by providing some other indication that he or she would like to participate in the interest assessment to identify industry sectors and/or roles that may be of interest.

In at least one example, the interest module 2006 may generate, access, and/or store interest assessments for completion by the job seekers to determine one or more industry sectors and/or roles that best matches the job seeker's preferences and/or qualifications. In some examples, the interest assessment may ask a plurality of questions to determine which industry sector and/or role best matches the job seeker's preferences and/or qualifications. In at least one example, the interest assessment may comprise a series of drop-down questions from which the job seeker may select an answer that most appropriately describes the job seeker (e.g., preference and/or qualifications). In additional or alternative examples, the interest assessment may include a series of questions associated with a decision tree. Based at least in part on the job seekers answers to the questions, the interest module 2006 may recommend one or more industry sectors and/or roles that may be of interest to the job seeker. In some examples, the interest module 2006 may recommend industry sectors and/or roles based on recruiters who subscribe to the services provided by the service provider 102 and industry sectors and/or roles associated with those recruiters.

The training module 120 may identify one or more training activities, such as training programs, exercises, and/or projects that may improve one or more skills in the skill set. The training module 120 may recommend and facilitate the training activities. The training module 120 may include at least a recommendation module 2008, a skill building module 2010, a data module 2012, etc. The recommendation module 2008 may determine and recommend the training activities to the job seeker and the skill building module 2010 may facilitate online training exercises and/or projects. The data module 2012 may receive updated data as a result of the job seeker completing the training exercises and/or projects.

Based at least in part on the competence score associated with a job seeker, the recommendation module 2008 may determine and recommend to the job seeker one or more training activities for strengthening one or more of the skills in the skill set. The recommendation module 2008 may determine training activities based at least in part on a gap analysis described below. The training activities may include in-person training programs (e.g., workshops, classes, retreats, etc.) and/or online training exercises and/or projects, described below. The online training exercises may be called “skill ups” and the online training projects may be called “challenges.” In at least one example, the skill ups may be directed to improving a single skill in the skill set and the challenges may be directed to improving one or more skills in the skill set.

The data module 2012 may collect data as a result of the job seeker completing the training exercises and/or projects. In at least some examples, the data module 2012 may collect the data items for a job seeker's electronic portfolio that may be stored in the information module 116 and/or database 126. Additionally, the data module 2012 may collect coaches' feedback. Before, during, and/or after the various training activities, job seekers may interact with coaches (e.g., in person, virtually, etc.). Coaches may provide feedback on the job seeker's progress and may input data that may be associated with the job seeker's profile.

The matching module 122 may leverage the determined competency of the job seekers, compatibility (e.g., fitness) with respect to particular recruiters and/or employers, interest specific to industry sectors (e.g., job tracks), and other relevant information to match two or more users 106 (e.g., job seekers and recruiters and/or employers) and/or recommend one or more employment opportunities to a job seeker. The matching module 122 may access the data stored in the information module 116, database 126, cloud storage, or other data repository. The data may include data associated with the job seeker's competence score determined from the competence assessment or updated after completion of one or more exercises, the job seeker's compatibility data, and/or the job seeker's interest data. The matching module 122 may also access data items associated with examples of completed projects and other relevant information about the job seeker.

The matching module 122 may leverage the data associated with the job seekers (e.g., competence scores, etc.) and data associated with one or more recruiters and/or employers (e.g., predetermined criteria, etc.) to match the job seeker with one or more of the recruiters and/or employers. In at least one example, the competence score and/or scores with respect to individual skills of the skill set may be used to match a job seeker to a recruiter and/or employer or a job seeker to a specific employment opportunity and/or industry sector offered by an employer. In at least one example, the matching module 122 may recommend employment opportunities to job seekers and/or job seekers to recruiters and/or employers based at least in part on a particular job seeker's competence score and/or scores with respect to individual skills of the skill set meeting predetermined thresholds. At least one of the predetermined thresholds may include a threshold score representing a minimum competence score required by an employer for employment consideration. That is, the threshold score may be indicative of a score the job seeker should achieve to be considered by the employer or for a particular role and/or employment opportunity, as described above. The predetermined thresholds may also include individual threshold scores representing minimum scores that correspond to the individual skills in the skill set.

The matching module 122 may also leverage the compatibility data and interest data in matching the job seeker with one or more of the recruiters and/or employers. The matching module 122 may leverage additional user information to make such recommendations. In at least one example, the matching module 122 may leverage GPS location, preferences, social networks, etc. for recommending employment opportunities to job seekers and/or job seekers to recruiters and/or employers. The matching module 122 may also enable recruiters to search through a plurality of job seekers by leveraging the threshold scores and/or individual thresholds scores corresponding to the individual skills of the skill set as filters to filter out individual job seekers with competence scores and/or scores with respect to the individual skills of the skill set below the threshold scores.

The presentation module 124 may generate personalized user interfaces that provide various functionalities to summarize information associated with job seekers, employers, recruiters, universities or other educational institutions, parents, etc. and/or enable job seekers, employers, recruiters, universities or other educational institutions, parents, etc. to interact with one another and/or the service provider 102. Various, non-limiting examples of graphical user interfaces are shown in FIGS. 2-17, 21-23, and 27-30.

### Example Processes

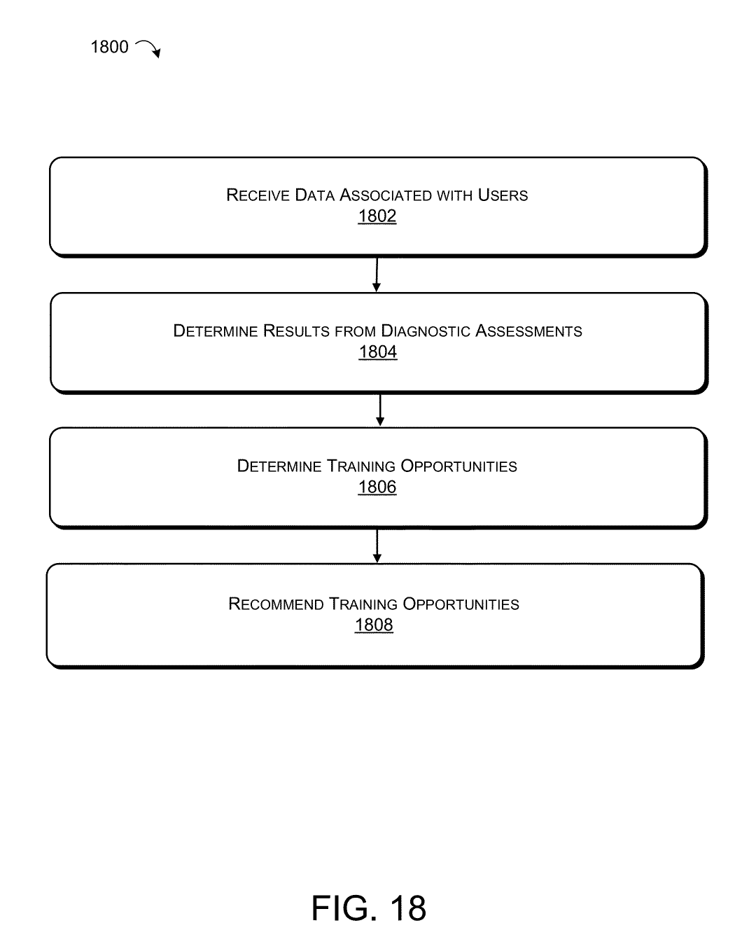

FIGS. 18, 19, 24, 25, and 26 describe example processes for determining a job seeker's competency with respect to performing individual skills associated with a skill set, recommending and providing one or more training activities to the job seeker, and leveraging the determined competency to match the job seeker with one or more recruiters and/or employers and/or recommend employment opportunities to the job seeker. The example processes are described in the context of the environment of FIGS. 1 and 20 but are not limited to those environments. The processes are illustrated as logical flow graphs, each operation of which represents a sequence of operations that can be implemented in hardware, software, or a combination thereof.

FIG. 18 illustrates an example process 1800 for determining a job seeker's competency with respect to his or her performance of individual skills of a skill set and recommending one or more training activities to the job seeker.

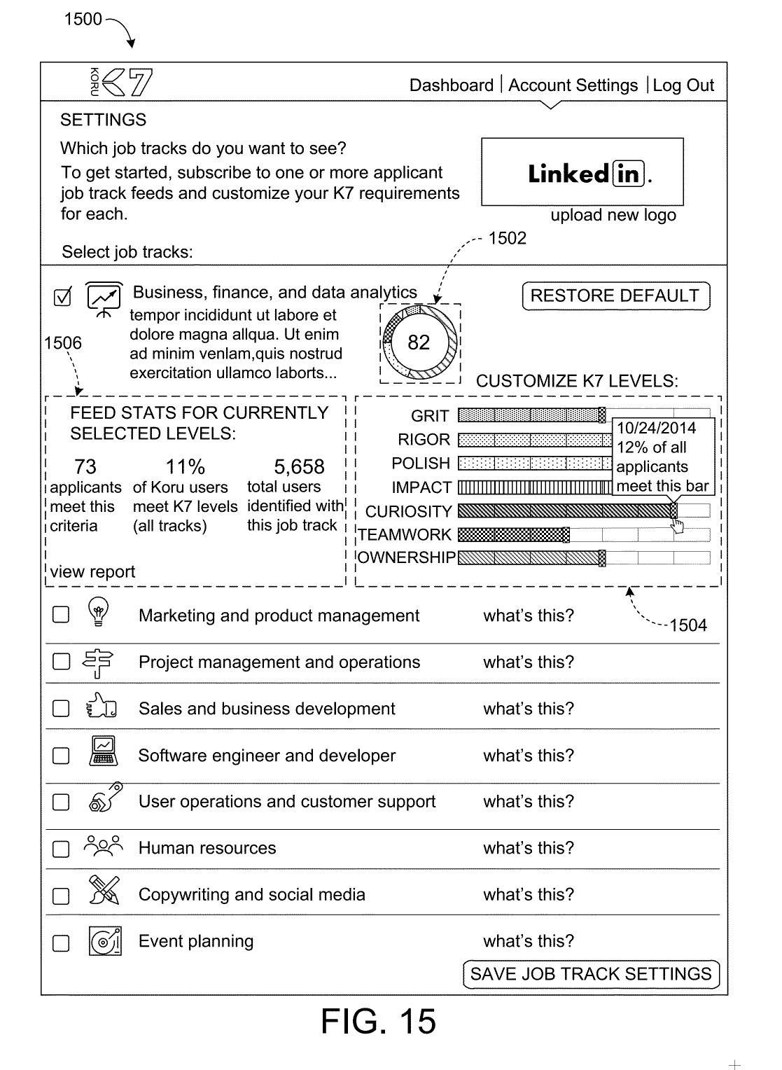

Block 1802 illustrates receiving data associated with the users 106. The information module 116 and/or database 126 may access, receive, and/or store data associated with the users 106, as described above. In at least one example, users 106 may input data into the information module 116 via personalized user interfaces configured to provide functionality to the users 106 to input the data. The data may be associated with a user profile corresponding to job seekers, recruiters, employers, etc. that is stored in the information module 116 and/or database 126. In at least some examples, the information module 116 may receive information from the users 106 based at least in part on requesting information from the users 106. FIGS. 15, 21, and 22 illustrate examples of user interfaces for providing functionality to users 106 to input data associated with the users 106.

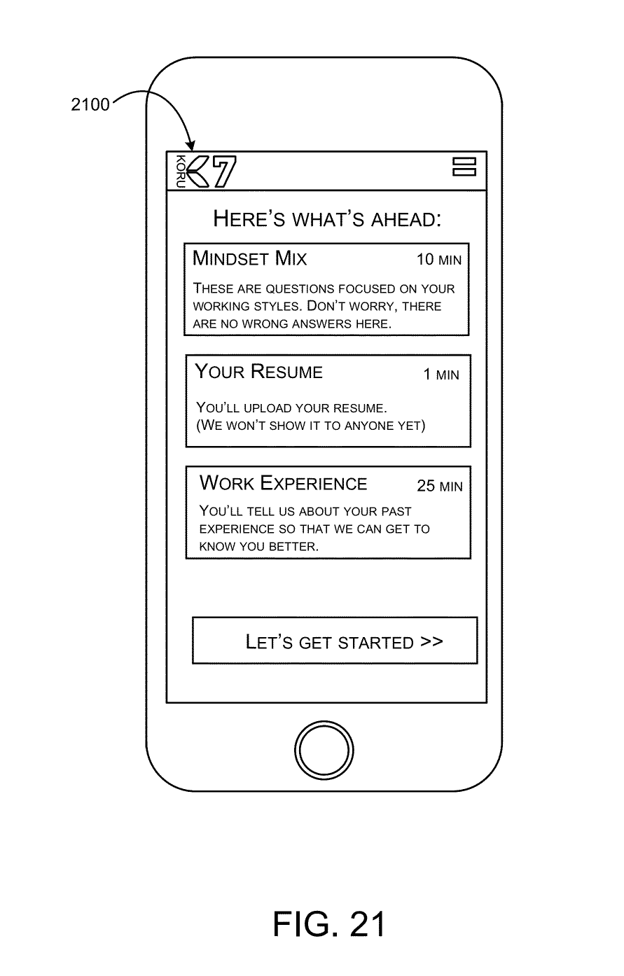

FIG. 21 illustrates an example user interface 2100 personalized for a job seeker to provide functionality to the job seeker to access diagnostic assessments (e.g., “Mindset Mix,” “Work Experience,” etc.), upload a resume, etc.

FIG. 15 is an example user interface 1500 personalized for recruiters and/or employers that may be caused to be presented by the presentation module 124 to provide recruiters and/or employers the functionality to input predetermined criteria for a particular employment opportunity, role, and/or industry sector. In at least one example, the predetermined criteria may include a minimum threshold score and/or minimum threshold scores for one or more of the individual skills in the skill set, as described above. As illustrated in FIG. 15, for the job track of business, finance, and data analytics, the recruiter and/or employer input a competence score of 82, as illustrated in box 1502 and input specified scores for each of the individual skills in the skill set at illustrated in box 1504. In some examples, the predetermined criteria may include a minimum threshold of the confidence score. The recruiters and/or employers may also input additional criteria such as geographic location, threshold grade point average, etc. In some examples, the recruiters and/or employers may indicate whether the additional criteria is required for a match or preferred for a match. User interface 1500 may also present information that summarizes how many job seekers meet the predetermined criteria as illustrated in box 1506.

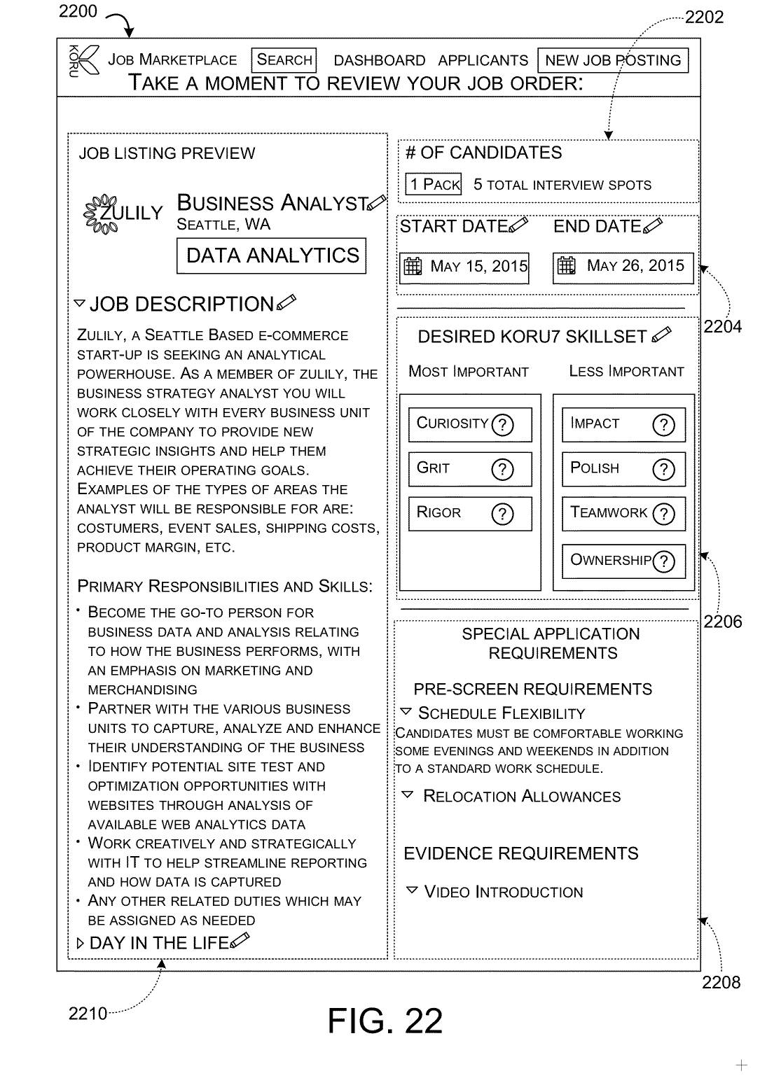

FIG. 22 is another example user interface 2200 personalized for recruiters and/or employers that that may be caused to be presented by the presentation module 124 to provide recruiters and/or employers the functionality to input predetermined criteria and additional criteria for a particular employment opportunity, role, and/or industry sector. As illustrated in box 2202, recruiters and/or employers may input a number of candidate job seekers that they would like to interview and/or review for the particular employment opportunity. Additionally, as illustrated in box 2204, recruiters and/or employers may input a start date associated with a posting for the particular employment opportunity and/or an end date associated with the posting for the particular employment opportunity. Recruiters and/or employers may input predetermined criteria associated with individual skills in the skill set. In some examples, the recruiters and/or employers may input preferences with respect to which skills in the skill set are most important or least important, as illustrated in box 2206. In other examples, the recruiters and/or employers may input thresholds associated with the competence score, scores with respect to individual skills in the skill set, etc. Moreover, recruiters and/or employers may also input additional criteria associated with an employment opportunity (e.g., schedule flexibility, relocation allowances, evidence requirements (associated with the pre-interview), citizenship requirements, etc.), as illustrated in box 2208. Recruiters and/or employers may also input information about the recruiter and/or employer, a description of the specific employment opportunity, responsibilities and skills associated with the particular specific activity, as illustrated in box 2210.

Block 1804 illustrates determining results from diagnostic assessments. The diagnostic module 118 may provide diagnostic assessments to job seekers and receive results from the diagnostic assessments. The diagnostic assessments may determine a competency of a job seeker with respect to a skill set, a compatibility of a job seeker with respect to particular employers, and/or interests of a job seeker with respect to one or more industry sectors and/or roles. The diagnostic module 118 may output quantitative feedback that may include a competence score as described above and/or individual scores corresponding to each of the skills in the skill set. Additionally, the diagnostic module 118 may output a confidence score representative of a level of confidence associated with the competence score. The level of confidence may be based on a familiarity of the service provider 102 with a job seeker and/or the job seeker's level of interaction with the service provider 102. For instance, if the job seeker is a new user 106 and the information stored in the information module 116 and/or database 126 is limited to the competence score, the confidence score may be below a predetermined threshold. In contrast, if the job seeker is a returning user 106 and the information stored in the information module 116 and/or database 126 includes the competence score, data collected from completed training activities, etc., the confidence score may be above a predetermined threshold.

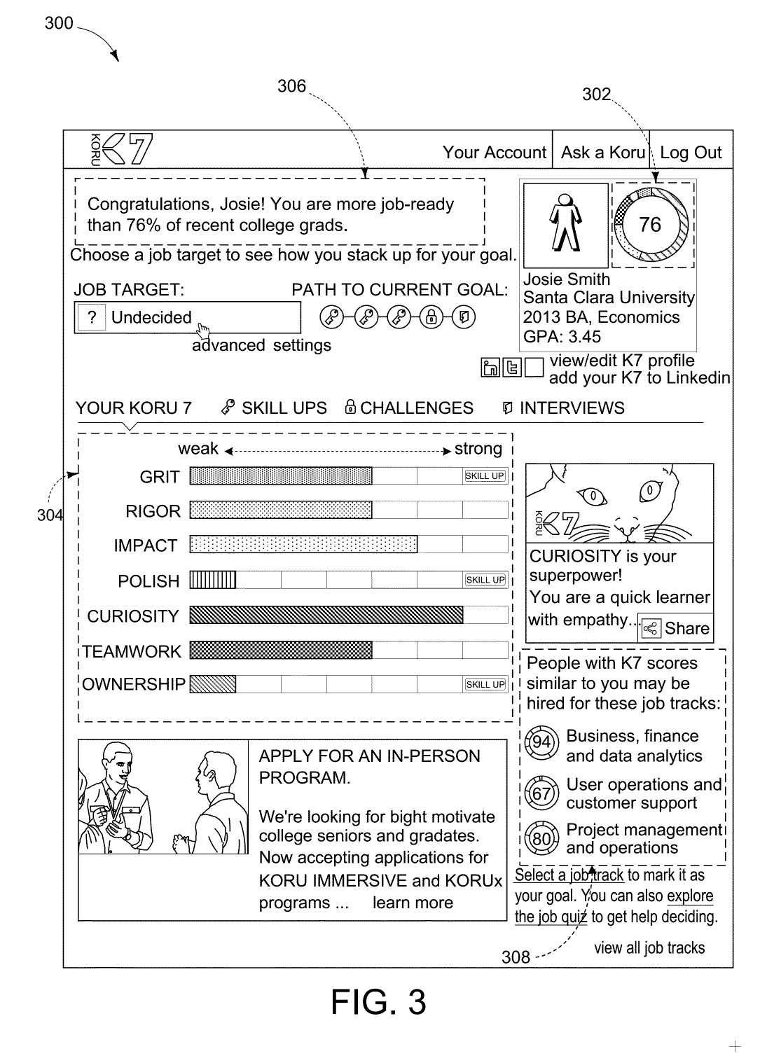

The presentation module 124 may generate and cause one or more personalized user interfaces to be presented to the job seeker to provide quantitative feedback on the job seekers' competency with respect to the set of skills, as illustrated in FIGS. 3, 4, and 23. FIG. 3 is an example user interface 300 that may be presented by the presentation module 124 to inform a job seeker of his or her competence score corresponding to a skill set. In FIG. 3, the job seeker's competence score is 76, as shown in box 302, and the job seeker's scores with respect to each of the individual skills in the skill set are shown in box 304. In at least one example, the job seeker's scores that correspond to each of the individual skills may be graphically represented to visually summarize the job seeker's strongest skills in the skill set and the job seeker's weakest skills in the skill set. For instance, in FIG. 3, the circle encompassing the competence score in box 302 visually summarizes that the job seeker's performance on the skill curiosity is better than the job seeker's performance on the skill grit.

The job seeker may use the quantitative feedback to determine which of the skills in the skill set he or she is particularly strong (e.g., “strong”) and which of the skills in the skill set he or she may need training to strengthen (e.g., “weak”). In at least some examples, the quantitative feedback may be provided in comparison to other job seekers. For example, in FIG. 3, the job seeker's competence score ranks her in the top 76% of other job seekers who are subscribing to the services offered by the service provider 102, as shown in box 306. In some examples, user interface 300 may also provide information with respect to industry sectors and/or roles that may be of interest to the job seeker based at least in part on competence scores of other job seekers, as illustrated in box 308.

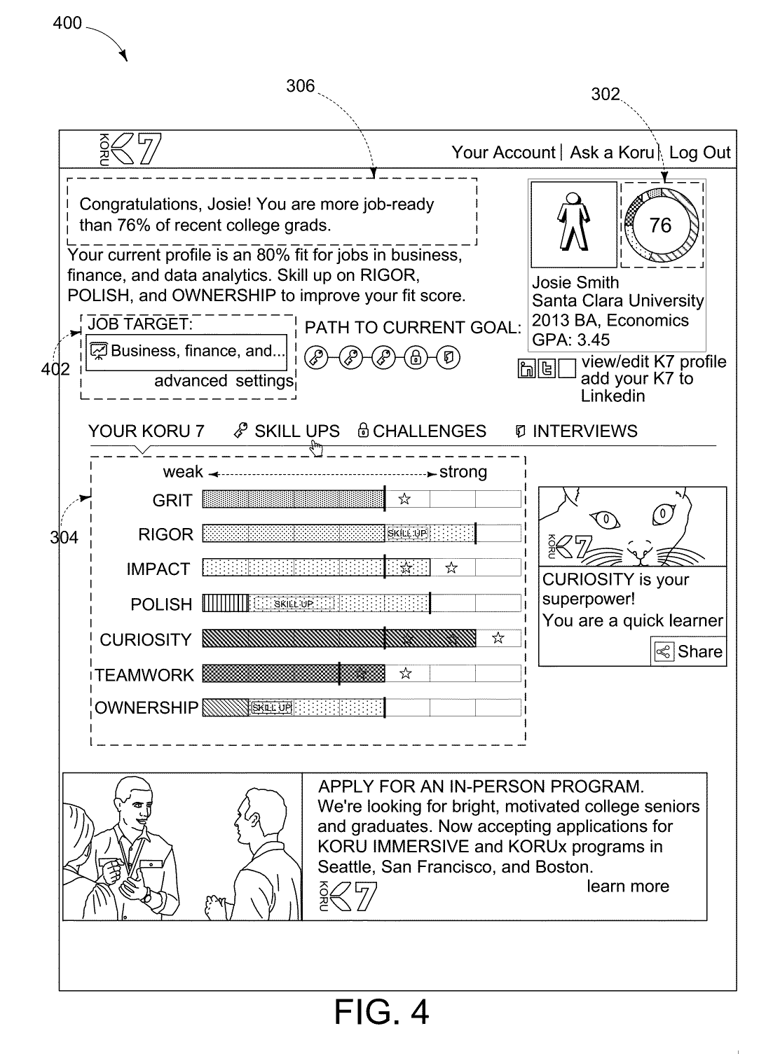

In additional or alternative examples, the quantitative feedback may be provided in the context of particular industry sectors, roles, and/or employment opportunities, as illustrated in FIG. 4. FIG. 4 illustrates a user interface 400 that may be presented by the presentation module 124 to inform a job seeker of his or her competence score and/or scores associated with one or more of the individual skills in the skill set in view of a target industry sector, role, etc. As illustrated in FIG. 4, the job seeker may choose an industry sector, role, etc., of interest as shown in box 402. The user interfaces presented to the job seeker by the presentation module 124 may have additional information relevant to the job seeker's diagnostic assessments, employment search, etc. In at least one example, after job seekers have identified industry sectors, roles, and/or employment opportunities of interest, the diagnostic module 118 may compare the job seeker's competence score and individual scores corresponding to individual skills in the skill set with a threshold score and respective individual threshold scores corresponding to individual skills of the skill set that indicate the minimum scores a job seeker should achieve to be considered for employment opportunities in the industry, role, and/or particular employment opportunities and may cause the presentation module 124 to present information identifying the individual skills the job seeker is deficient in, as shown in box 304. For instance, in FIG. 4, the job seeker's scores with respect to the skills rigor, polish, and ownership are below the threshold for being eligible for a business, finance, and data analytics industry sector as identified in box 402. As illustrated in FIG. 4, the black vertical lines in box 304 are associated with the individual threshold scores and the scores for the skills rigor, polish, and ownership are not shown to meet the individual threshold scores for those skills. Accordingly, the job seeker may elect to participate in one or more training activities to improve his or her score in those skills. User interface 400 illustrates this by indicating that the job seeker needs to “skill up” in the skills of rigor, polish, and ownership. As the job seekers' competence scores and scores corresponding to the individual skills improve via the training activities described below, job seekers can track their progress in achieving the threshold scores for target employment opportunities, industry sectors, roles, and/or employers.

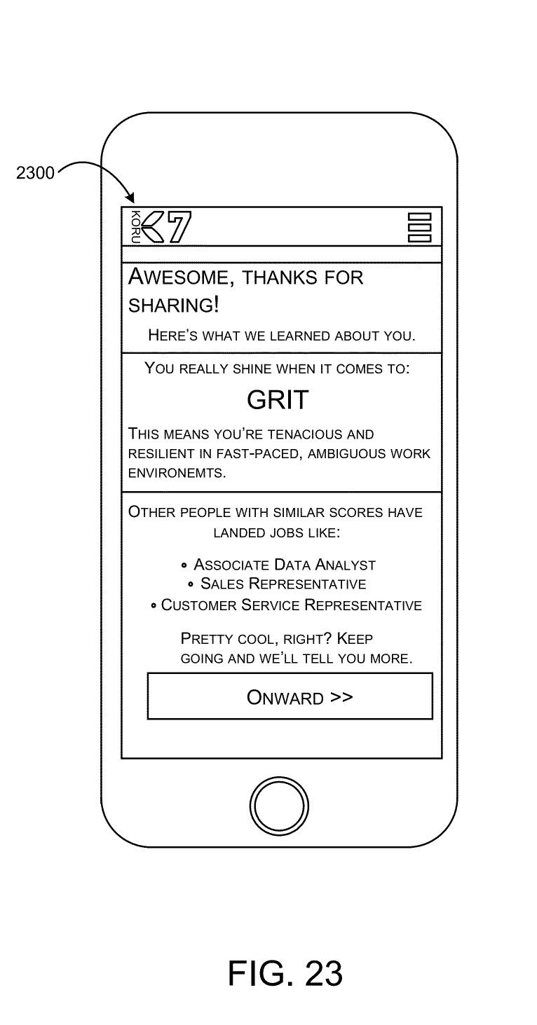

FIG. 23 illustrates an example user interface 2300 personalized for a job seeker to communicate information associated with the competency of the job seeker to various users 106. In FIG. 23, the job seeker may learn that he or she is strong in a particular skill of the skill set (e.g., grit).

Returning to FIG. 18, Block 1806 illustrates determining one or more training activities to improve one or more of the skills in the skill set. Based at least in part on the diagnostic assessment, the training module 120 may determine one or more training activities for strengthening one or more of the skills in the skill set. As described above, the training activities may include in-person training programs (e.g., workshops, classes, retreats, etc.) and/or online training exercises and/or projects. The recommendation module 2008 may recommend the training activities to the job seeker. The recommendation module 2008 may determine training activities based at least in part on a gap analysis.

In at least one example, the recommendation module 2008 may compare threshold scores determined by recruiters and/or employers with competence scores associated with individual job seekers to identify gaps. The threshold scores may represent the minimum competency corresponding to the skill set (e.g., total competence score) that the job seeker should achieve to be considered by the employer or for an employment opportunity or role. Individual threshold scores may represent individual threshold scores corresponding to individual skills in the skill set that the job seeker should achieve to be considered by the employer or for an employment opportunity or role. Individual threshold scores may also represent minimum scores for sub-skills corresponding to each of the individual skills in the skill set, threshold scores for confidence scores, etc. In at least one example, a job seeker may input employers, employment opportunities, roles, and/or industry sectors of which he or she is interested in working in (e.g., target employers, target roles, and/or target industry sectors) and the recommendation module 2008 compares the threshold scores associated with the target employers, employment opportunities, roles, and/or industry sectors with the competence score and/or confidence score associated with the individual job seeker. In some examples, a job seeker may not input an employer, employment opportunity, role, or industry sector of which he or she is interested in working. The recommendation module 2008 may retrieve results from the compatibility assessment and/or interest assessment to determine an employer, employment opportunity, role, or industry sector of which a job seeker appears to be interested in working and the recommendation module 2008 may compare the threshold scores associated with the determined employers, employment opportunity, roles, or industry sectors with the competence score and/or confidence scores associated with the individual job seeker.

The recommendation module 2008 may determine the individual skills in which the job seeker falls below the threshold score and may recommend one or more training activities to improve the individual skills. The recommendation module 2008 may identify individual skills in which the job seeker falls below the threshold score by comparing respective of the individual scores corresponding to each of the skills in the skill set and the individual threshold scores corresponding to each of the skills in the skill set and determining that an individual score of the individual scores is less than a respective individual threshold score of the individual threshold scores. In at least one example, the recommendation module 2008 may identify at least one skill in the skill set corresponding to the individual score that is less than the respective individual threshold score and determine a particular training activity that is associated with the at least one skill.

The recommendation module 2008 may recommend different training activities to different job seekers based on one or more parameters. The one or more parameters may include employers, employment opportunities, roles, and/or industry sectors that the individual job seekers have indicated an interest, scores associated with each of the individual skills, scores associated with sub-skills, confidence scores, etc. As a non-limiting example, the recommendation module 2008 may recommend different training activities to a job seeker who has indicated an interest in role A with employer A and a job seeker who has indicated an interest in role B with employer A. In an additional non-limiting example, the recommendation module 2008 may recommend different training activities to job seekers who have the same competence scores and have indicated interests in a same employer and/or role but have different scores with respect to one or more of the individual skills in the skill set.

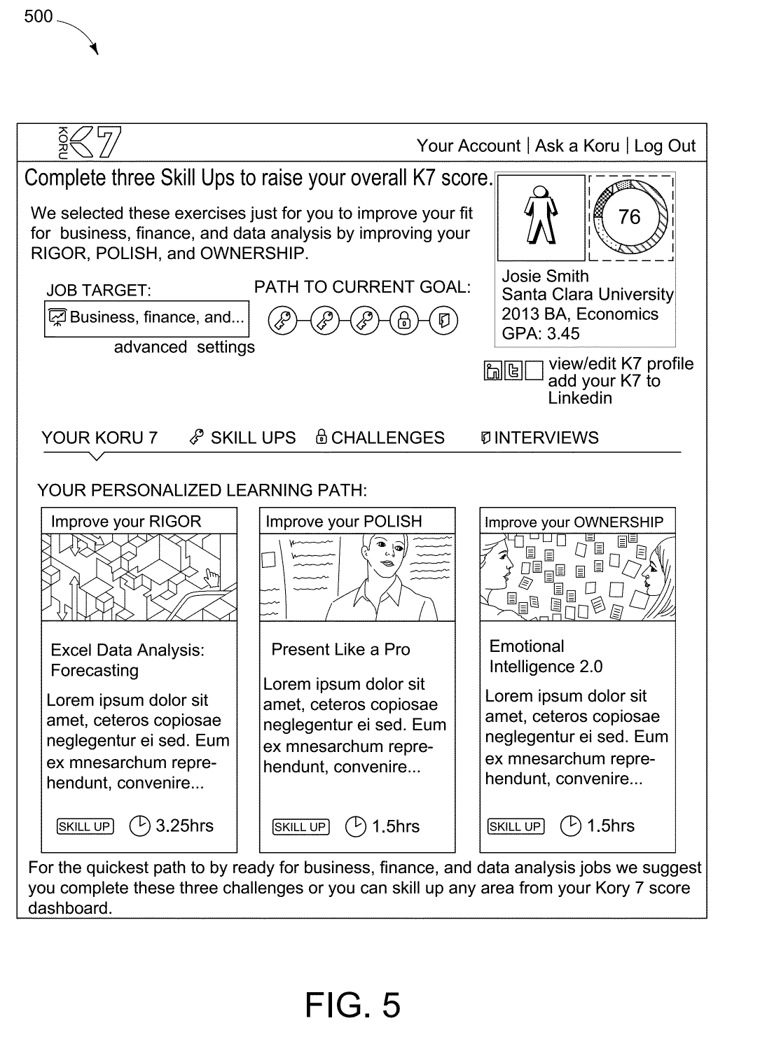

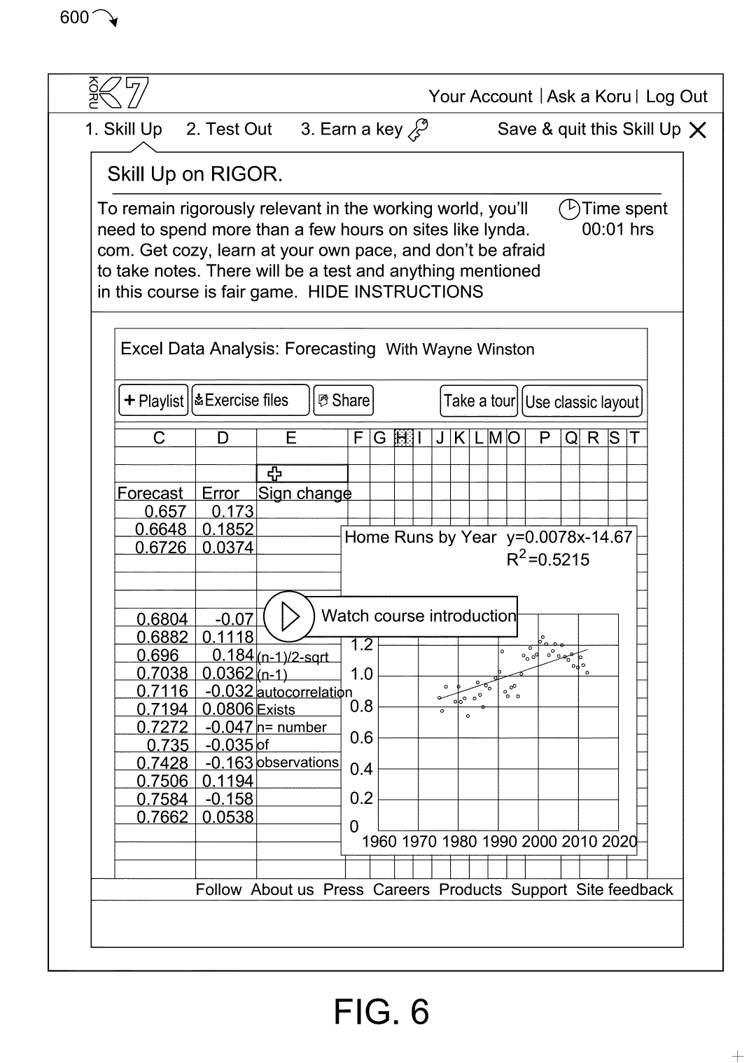

Block 1808 illustrates recommending one or more training activities to the job seeker. The skill building module 2010 may select one or more online training activities for the presentation module 124 to cause to be presented to the job seeker to strengthen one or more skills of the set of skills, as illustrated in FIG. 5. FIG. 5 illustrates an example user interface 500 that provides the functionality to recommend one or more training activities to a job seeker. For instance, in FIG. 5, the presentation module 124 may cause a user interface to be presented to the job seeker that includes access to three exercises for improving the skills of rigor, polish, and ownership. The job seeker may elect to participate in one of the recommended exercises or may elect to participate in an exercise directed to another skill of the set of skills and the skill building module 2010 may facilitate the training exercises. Exercises (e.g., “skill ups”) may represent online lectures, classes, programs, or facilitations that, once completed by the user 106, result in the user 106 acquiring a new skill or an improved proficiency in a skill. FIG. 6 is an example user interface 600 that provides a job seeker with functionality to participate in one of the recommended training activities (e.g., an exercise to improve a job seeker's rigor). Once a job seeker successfully completes an exercise, the job seeker's competence score and/or score for the skill corresponding to the exercise may be updated (e.g., increased) to reflect the newly acquired expertise. The job seeker's competence score may be increased based at least in part on the score for the skill increasing.

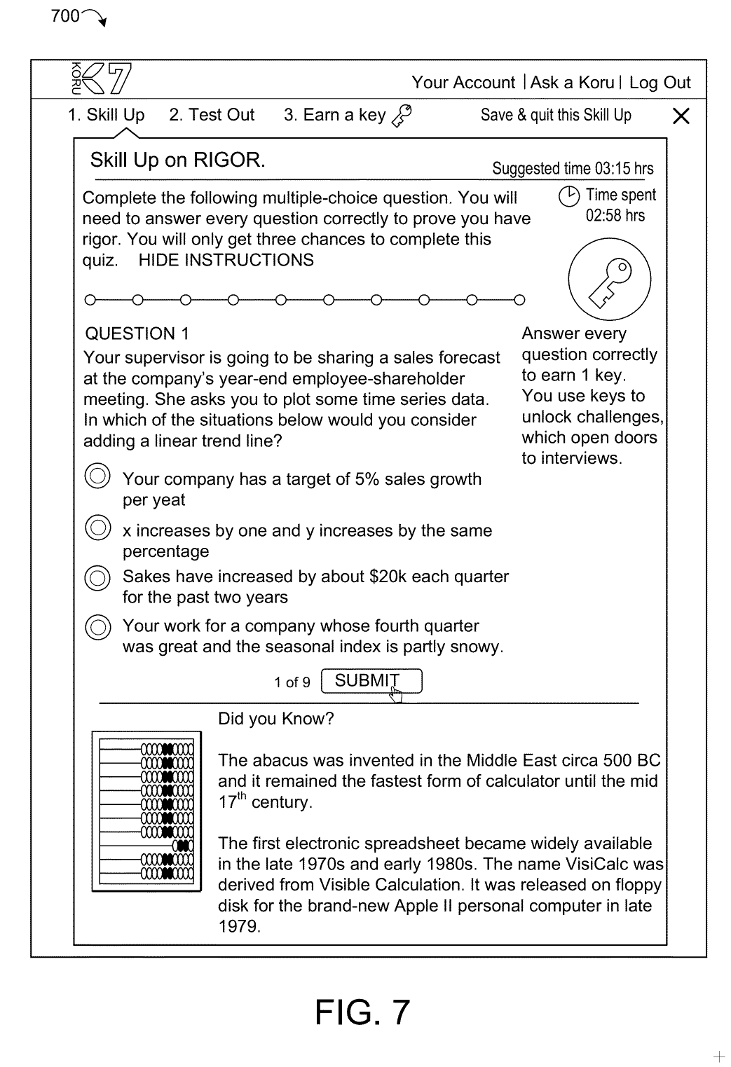

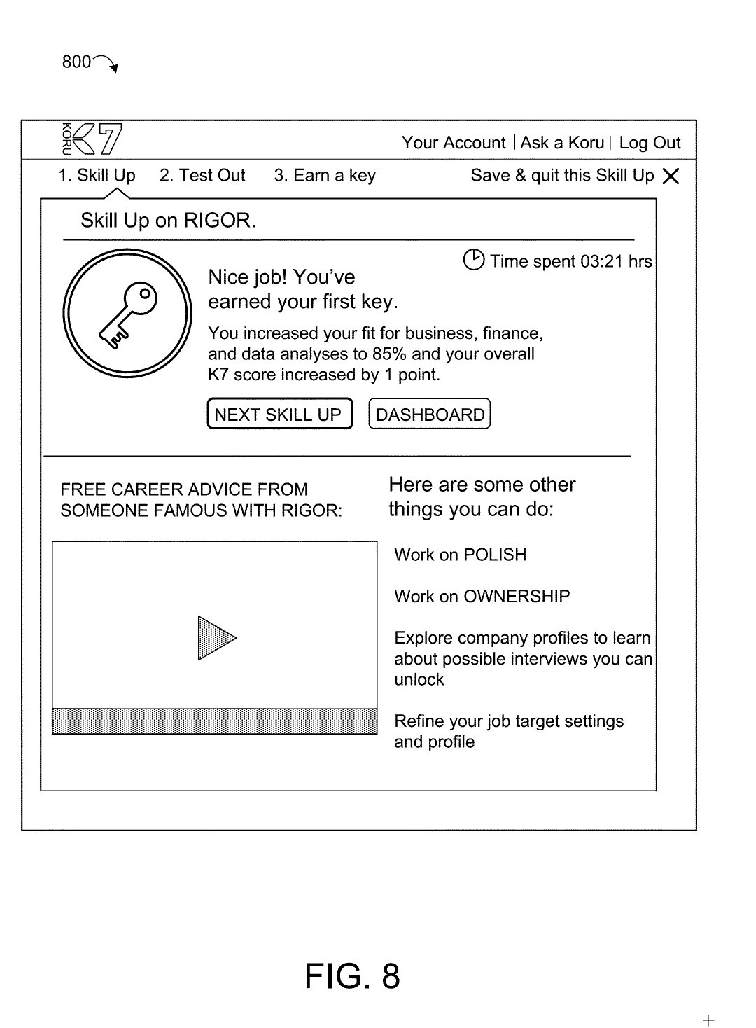

In some examples, a job seeker may be required to pass an exam before his or her competence score reflects completion of an exercise, as illustrated in FIG. 7. FIG. 7 is an example user interface 700 that provides a job seeker with functionality to participate in one of the recommended training activities. FIG. 8 illustrates an example user interface 800 that may be presented by the training, tracking, and placement system when a job seeker completes a training activity. The user interface 800 may also provide additional information relevant to the exercise and/or skill set.

In addition to exercises, the skill building module 2010 may select one or more projects (e.g., “challenges”) for the presentation module 124 to cause to be presented to the job seeker. In at least some examples, in order for a job seeker to be able to start a project, the job seeker may be required to have successfully completed a predetermined number of exercises and/or demonstrate competency with respect to his or her performance on a number of skills of the skill set. Projects may provide a job seeker with activities to use one or more of their skills to produce work product (e.g., data items) demonstrating their competency. The projects may have various levels of difficulties. In at least one example, completed projects (e.g., data items) may be associated with the electronic portfolios that are stored in the information module 116 and/or database 126 and may be used by the job seeker to demonstrate the job seeker's competency with respect to individual skills in the skill set. As job seekers complete more projects and exercises, the job seeker's competence and/or confidence scores may be updated. In at least some examples, a job seeker's competence score may stay the same but the confidence score may increase or decrease.

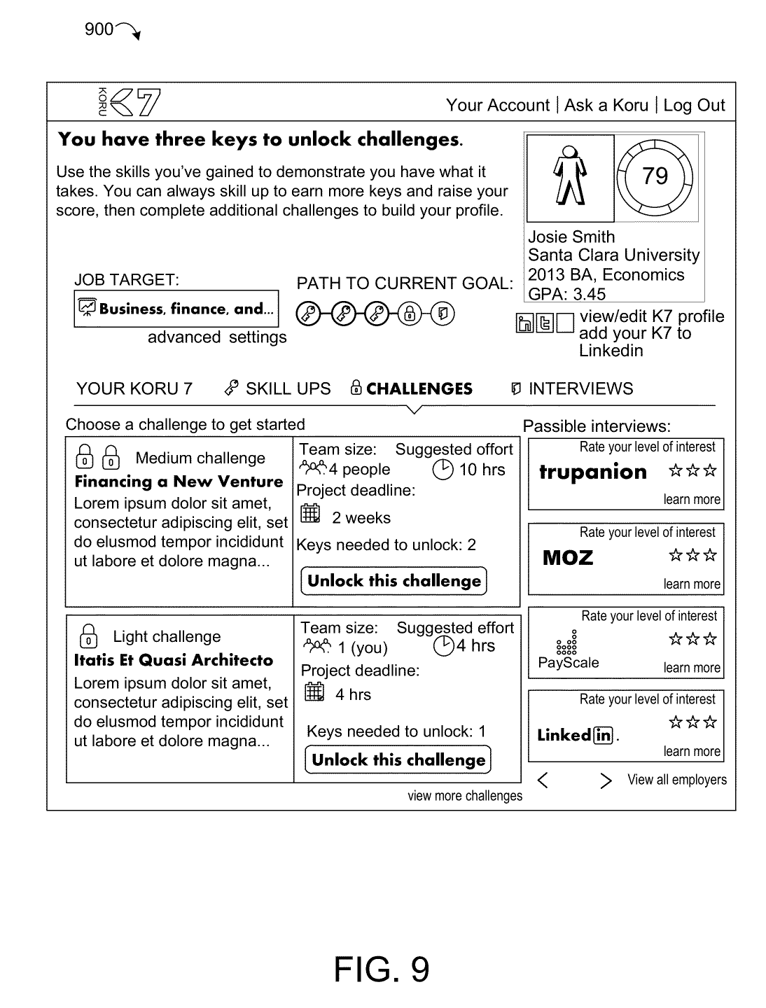

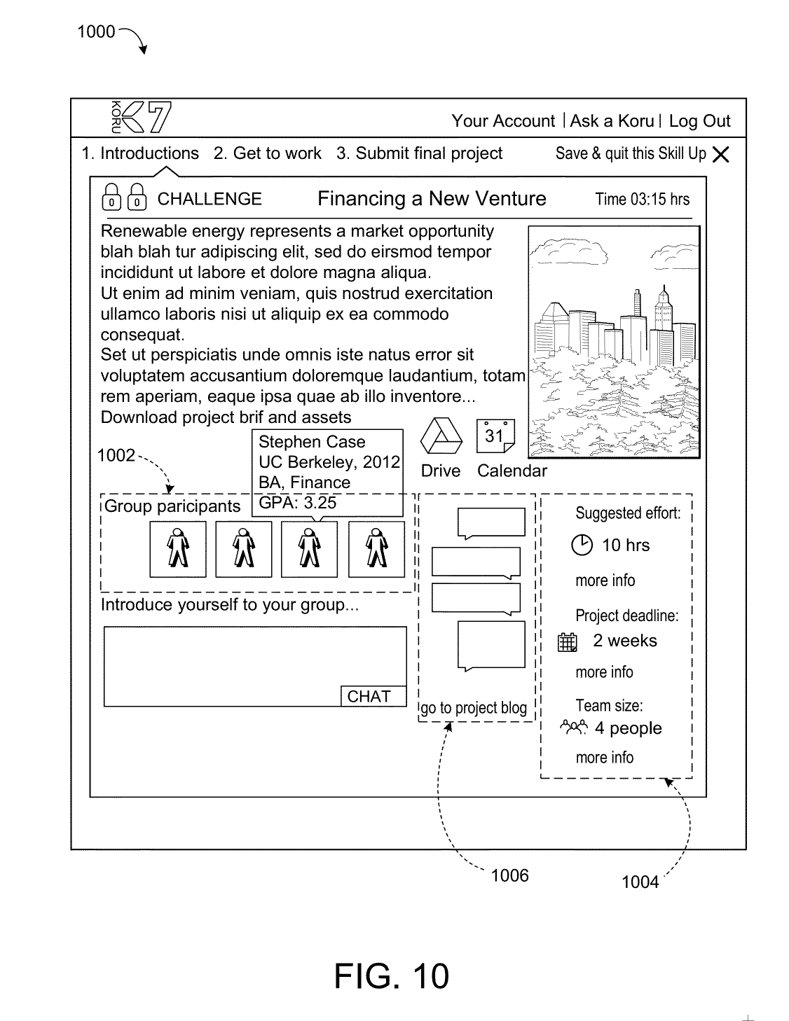

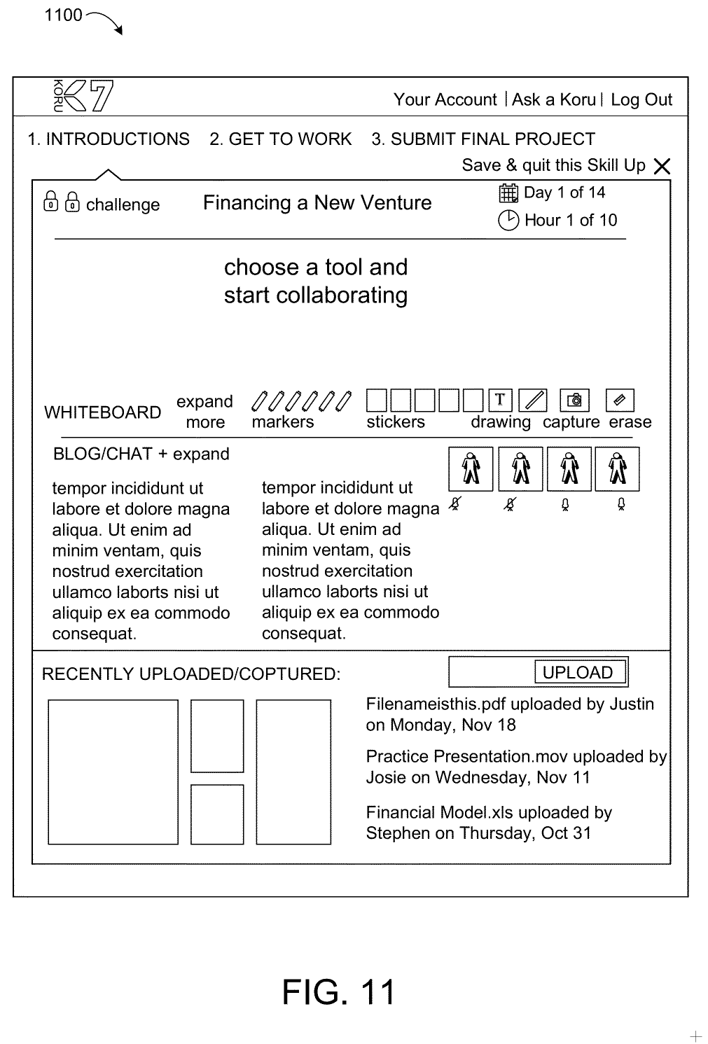

FIG. 9 is an example user interface 900 that may be caused to be presented by the presentation module 124 that provides a job seeker with functionality to elect to complete a training activity (e.g., “challenge”) associated with a particular skill. FIG. 10 is an example user interface 1000 that may be caused to be presented by the presentation module 124 that provides a job seeker with functionality to begin a training activity. In FIG. 10, the project is titled “Financing a New Venture.” In at least some examples, one or more job seekers may work together to complete the project. FIG. 10 illustrates four job seekers who may collaborate to complete the project in box 1002, but any number of job seekers may collaborate to complete the project based on the parameters of the project. User interface 1000 may also provide additional information about the project as shown in box 1004. The additional information may include a suggested time for completion of the project, project deadline, team size, etc. Additionally, user interface 1000 may include a portion of the interface where the job seekers may discuss the project as shown by box 1006. FIG. 11 is an example user interface 1100 that may be caused to be presented by the presentation module 124 that provides a job seeker with functionality to work on a training activity.

As job seeker's complete exercises (e.g., skill-ups) and projects (e.g., challenges), the data module 2012 receives data and/or data items. In at least one example, the data may include scores associated with the exercises and/or projects, peer assessments, coach assessments, work product, etc. The data may be structured, such as in a rubric, or may be free form. In at least some examples, coaches and/or peers (e.g., other job seekers) may provide structured and/or free-form commentary regarding the job seeker's performance on an exercise and/or project. Moreover, in at least some examples, the skill building module 2010 may provide data items (e.g., documents, videos, etc.) generated during an exercise and/or project. In at least some examples, the data module 2012 may send the data and/or data items to the information module 116 and/or database 126 for storage. In at least one example, the data and/or data items may be associated with the user profile and may be stored in the information module 116 and/or database 126. In other examples, the data module 2012 may send the data and/or data items to cloud storage or other data repository.

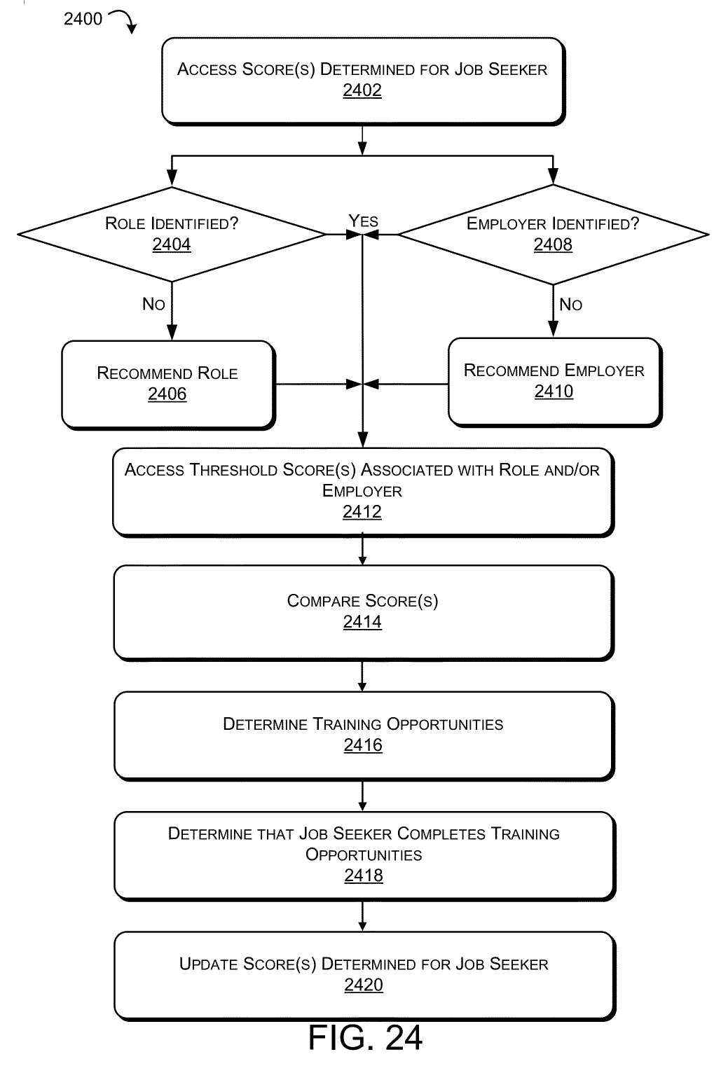

FIG. 24 illustrates an example process 2400 for determining a job seeker's competency with respect to his or her performance on individual skills of a skill set and recommending one or more training activities to the job seeker.

Block 2402 illustrates accessing data associated with a competence score and scores corresponding to individual skills in the skill set determined for a job seeker. As described above, the competency module 2002 may generate and/or access one or more diagnostic assessments to determine a job seeker's competence with respect to a skill set. After completion of the diagnostic assessment, the diagnostic module 118 may output a competence score for the user 106. The recommendation module 2008 may access data associated with the competence score and individual scores corresponding to each of the skills in the skill set.

Decision block 2404 illustrates determining whether the job seeker identified a particular role. In at least some examples, the diagnostic module 118 may prompt a job seeker for input regarding an intended role. The job seeker may provide an indication as to which role he or she is interested in, and therefore, the role may be identified as indicated by the “Yes” arrow pointing away from Block 2404. In an event the job seeker is unsure of which role he or she is interested in (as indicated by the “No” arrow pointing away from Block 2404), the interest module 2006 may provide interest assessments for completion by the job seeker to determine which role best matches the job seeker's preferences and/or qualifications. Block 2406 illustrates recommending a role for the job seeker. Based at least in part on the job seeker's answers to questions in the interest assessment, the interest module 2006 may determine one or more roles that may be of interest to the job seeker. In some examples, the interest module 2006 may determine roles based on recruiters and/or employers who subscribe to the services provided by the service provider 102 and roles associated with those recruiters and/or employers.

In some examples, the matching module 122 may determine whether the job seeker identified a particular industry sector (e.g., job track) and/or employment opportunity in addition to, or alternatively to, identifying a role. In an event the job seeker is unsure of which industry sector and/or employment opportunity he or she is interested in (as indicated by the “No” arrow pointing away from Block 2104), the interest module 2006 may provide interest assessments for completion by the job seeker to determine which industry sector and/or employment opportunity best matches the job seeker's preferences and/or qualifications. Based at least in part on the job seeker's answers to questions in the interest assessment, the interest module 2006 may determine one or more industry sectors and/or employment opportunities that may be of interest to the job seeker. In some examples, the interest module 2006 may determine industry sectors and/or employment opportunities based on recruiters and/or employers who subscribe to the services provided by the service provider 102 and industry sectors and/or employment opportunities associated with those recruiters and/or employers. As described above, in additional or alternative examples, the interest module 2006 may determine whether the job seeker has indicated an industry sector and/or employment opportunity and may recommend an industry sector and/or employment opportunity based on the interest assessment.

Decision block 2408 illustrates determining whether the job seeker identified a particular employer. In at least some examples, the diagnostic module 118 may prompt a job seeker for input regarding a particular employer. The job seeker may provide an indication as to an employer that he or she is interested in working for, and therefore, the employer may be identified as indicated by the “Yes” arrow pointing away from Block 2408. In an event that the job seeker does not have a particular employer in mind (as indicated by the “No” arrow pointing away from Block 2408), the job seeker may be interested in determining a type of work space where he or she may be a good fit. Block 2410 illustrates recommending an employer that may be of interest to the job seeker. The compatibility module 2004 may provide a compatibility assessment to the job seeker. Based at least in part on the job seeker's answers to the questions and/or selections of the compatibility assessment, the compatibility module 2004 may recommend one or more employers that may be of interest to the job seeker. In some examples, the compatibility module 2004 may recommend employers based on employers who subscribe to the services provided by the service provider 102.

Block 2412 illustrates accessing data associated with threshold score(s) associated with a role and/or recruiter and/or employer. In at least some examples, recruiters and/or employers may input data associated with predetermined criteria for a particular employer, employment opportunity, role, etc. The information module 116 and/or database 126 may store the data associated with the predetermined criteria. In additional or alternative examples, the data associated with the predetermined criteria may be stored in cloud storage or another data repository. In at least one example, the predetermined criteria may include a threshold score and/or individual threshold scores for each of the individual skills in the skill set. The threshold score may be based at least in part on the individual threshold scores corresponding to each of the skills in the skill set. In some examples, the predetermined criteria may include a threshold of the confidence score. The recruiters and/or employers may also input data associated with additional criteria such as geographic location, threshold grade point average, etc. In some examples, the recruiters and/or employers may indicate whether the additional criteria is required for a match or preferred for a match. Based at least in part on determining the role, industry sector, employer, etc., the recommendation module 2008 may access data associated with respective individual minimum threshold scores corresponding to each of the individual skills in the skill set. The recommendation module 2008 may access the threshold competence score and individual threshold scores corresponding to each of the skills in the skill set.

Block 2414 illustrates comparing the job seeker's competence score and individual scores corresponding to the individual skills in the skill set with the threshold score and respective individual threshold scores that are associated with the determined role, industry sector, employer, etc. The recommendation module 2008 may compare respective of the individual scores corresponding to each of the skills in the skill set and the individual threshold scores corresponding to each of the skills in the skill set. In at least some examples, the recommendation module 2008 may determine that an individual score of the individual scores is less than a respective individual threshold score of the individual threshold scores.

Block 2416 illustrates determining training activities. Based at least in part on comparing the job seeker's competence score with the threshold scores associated with the role, industry sector, employer, etc., the recommendation module 2008 may determine one or more training activities for strengthening one or more of the skills in the skill set based on the gap analysis as described above. In at least one example, the recommendation module 2008 may determine that an individual score of the individual scores is below a respective individual threshold score of the individual threshold scores. The recommendation module 2008 may identify at least one skill in the skill set corresponding to the individual score that is below the respective individual threshold score and may recommend a particular training activity associated with the at least one skill. As described above, the training activities may include in-person training programs (e.g., workshops, classes, retreats, etc.) and/or online training exercises and/or projects. The skill building module 2010 may provide online training activities to the job seekers and the data module 2012 may receive data and/or data items associated with the online training activities. In at least one example, the data may include scores associated with the exercises and/or projects, peer assessments, coach assessments, etc. and the data items may be associated with work product, etc. In at least one example, the data and/or data items may be associated with the user profile and may be stored in the information module 116, database 126, cloud storage, and/or other data repository.

Block 2418 illustrates determining that the job seeker completes the training activities. Based at least in part on data collected by the data module 2012, the training module 120 may determine that the job seeker completed at least one of the recommended training activities.

Block 2420 illustrates updating the competence score and/or individual scores corresponding to individual skills in the skill set. As described above, after a job seeker successfully completes an exercise and/or project, the job seeker's score for the skill corresponding to the training activity may be increased to reflect the newly acquired expertise. In at least one example, based at least in part on determining that the job seeker completed a training activity corresponding to a particular skill in the skill set, the data module 2012 may update the score associated with that particular skill. Based at least in part on updating the score associated with the particular skill, the data module 2012 may update the competence score.

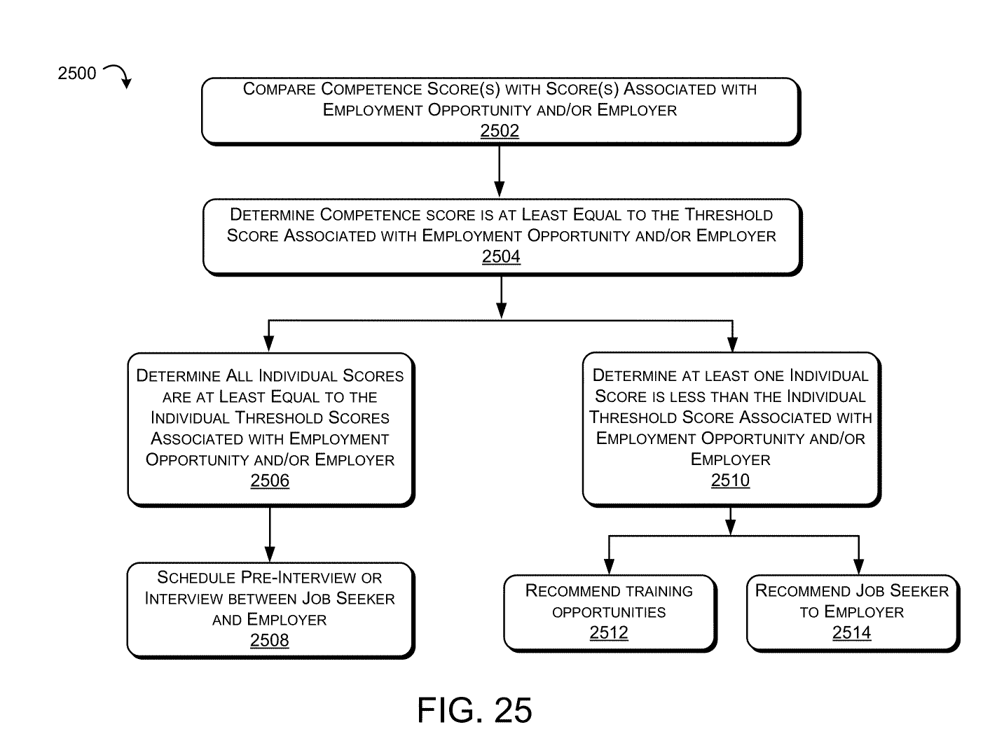

FIG. 25 describes an example process 2500 for comparing the job seeker's competence score with a threshold score associated with an employer or employment opportunity.

Block 2502 illustrates comparing competence score(s) with the threshold score(s) associated with an employer and/or employment opportunity. The matching module 122 may compare the competence score and individual scores corresponding to the individual skills in the skill set with threshold scores associated with a particular employer and/or employment opportunity.

Block 2504 illustrates determining that the competence score at least equals the threshold score for the employer and/or employment opportunity. In at least one example, the matching module 122 may determine that the competence score is equal to or greater than the threshold score associated with the particular employer and/or employment opportunity.

Block 2506 illustrates determining that all of the individual scores are at least equal to the individual threshold scores associated with the employer and/or employment opportunity. In at least one example, the matching module 122 may determine that all of the job seeker's individual scores are equal to or greater than the respective individual threshold scores. In such examples, the matching module 122 may schedule a pre-interview or interview between the job seeker and employer. Block 2508 illustrates scheduling a pre-interview or interview between the job seeker and the employer.

Block 2510 illustrates determining that at least one of the individual scores is less than the respective individual threshold score. In at least some examples, the matching module 122 may determine that one or more of the individual score is less than the individual threshold scores associated with the particular employer and/or employment opportunity. In such examples, the training module 120 may recommend one or more additional training activities for the job seeker to improve his or her individual score(s), as illustrated in Block 2512. In other examples, the job seeker's competence score may be at least equal to the threshold score but one or more of the job seeker's individual scores corresponding to the individual skills may not be equal to the threshold scores associated with the employer and/or employment opportunity. In such examples, the matching module 122 may recommend the job seeker to the employer and the employer may consider the job seeker's electronic portfolio and other user information to decide whether to offer the job seeker an interview. Block 2514 illustrates recommending the job seeker to the employer.

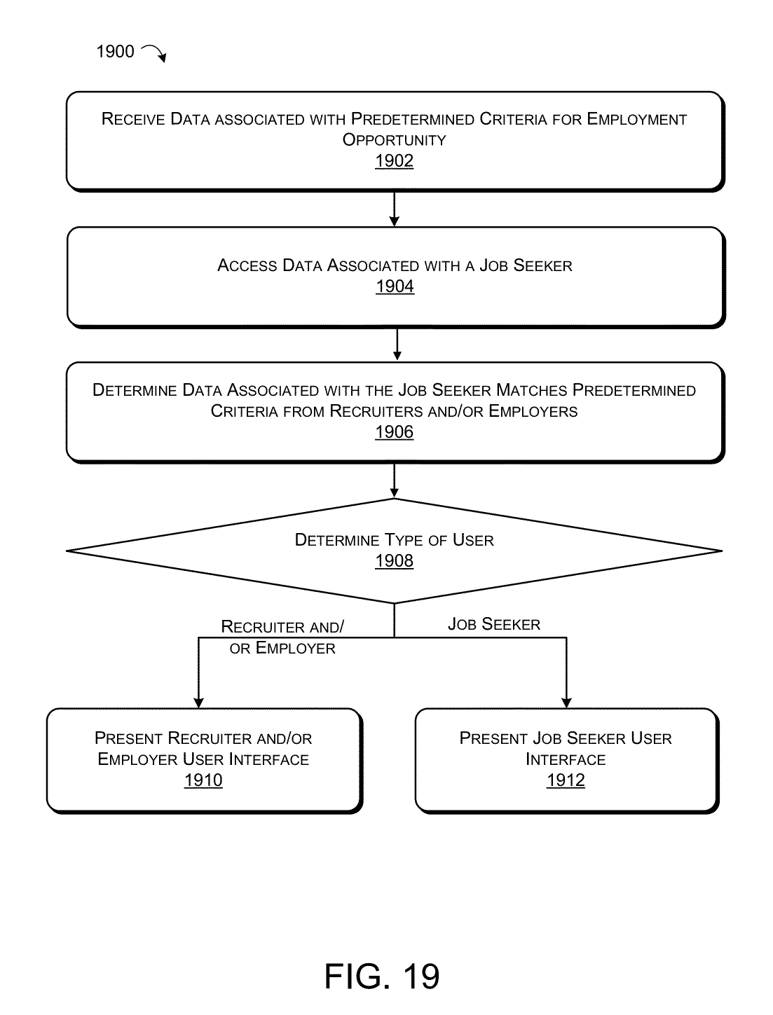

FIG. 19 describes an example process 1900 for leveraging a job seeker's determined competence score for matching the job seeker with one or more one or more recruiters and/or employers.

Block 1902 illustrates receiving data associated with predetermined criteria for a particular employer, employment opportunity, and/or role. Recruiters and/or employers may input data associated with predetermined criteria for a particular employer, employment opportunity, role, etc., as illustrated in FIGS. 15 and 22.

Block 1904 illustrates accessing data associated with a job seeker. The matching module 122 may access the data and/or data items stored in the information module 116, database 126, cloud storage, and/or other data repository corresponding to the job seeker. The data may include data associated with the job seeker's competence score and/or scores corresponding to each of the skills in the skill set as determined by the diagnostic assessment or updated after completion of one or more exercises. The data items may include examples of completed projects that are stored in an electronic portfolio associated with a user profile corresponding to the job seeker and data associated with other relevant information about the job seeker as described above.

Block 1906 illustrates determining that data associated with the job seeker matches predetermined criteria from recruiters and/or employers. The matching module 122 may leverage the data associated with the job seeker to match the job seeker with one or more of the recruiters, employers, and/or employment opportunities. In at least one example, the competence score and/or scores with respect to individual skills of the skill set may be used to match a job seeker to a recruiter and/or an employer or a job seeker to a specific employment opportunity offered by an employer. In at least one example, the matching module 122 may recommend employment opportunities to job seekers and/or job seekers to recruiters and/or employers based at least in part on a particular job seeker's competence score and/or scores with respect to individual skills of the skill set being above a predetermined threshold. The matching module 122 may leverage data from user profiles to make such recommendations. In at least one example, the matching module 122 may leverage data associated with the job seeker's GPS location, preferences, social networks, etc. for recommending employment opportunities to job seekers and/or job seekers to recruiters and/or employers. The matching module 122 may also enable recruiters and/or employers to search through a plurality of job seekers by leveraging the threshold scores and/or individual threshold scores with respect to the individual skills of the skill set as filters to filter out any job seekers of the plurality of job seekers with competence scores and/or scores with respect to the individual skills of the skill set below a threshold. Recruiters and/or employers may search through a plurality of job seekers by utilizing additional and/or alternative filters including, but not limited to, geographic location of the job seekers, interest scores associated with the job seekers, etc.

Decision block 1908 illustrates determining a type of a user 106. For instance, the presentation module 124 may leverage user information to determine whether a user 106 is a job seeker, a recruiter, an employer, etc. The presentation module 124 may generate user interfaces that are personalized to each type of user 106 (e.g., job seekers, recruiters, employers, etc.) and provide various functionalities for the different types of users 106 to interact with one another and/or the service provider 102.

Depending on whether the user 106 is a recruiter and/or employer or a job seeker, Blocks 1910 and 1912 illustrate presenting appropriate user interfaces. Based at least in part on determining whether the user 106 is a job seeker or recruiter and/or employer, the presentation module 124 may generate and cause a particular user interface to be presented to the user 106 via a device 108.

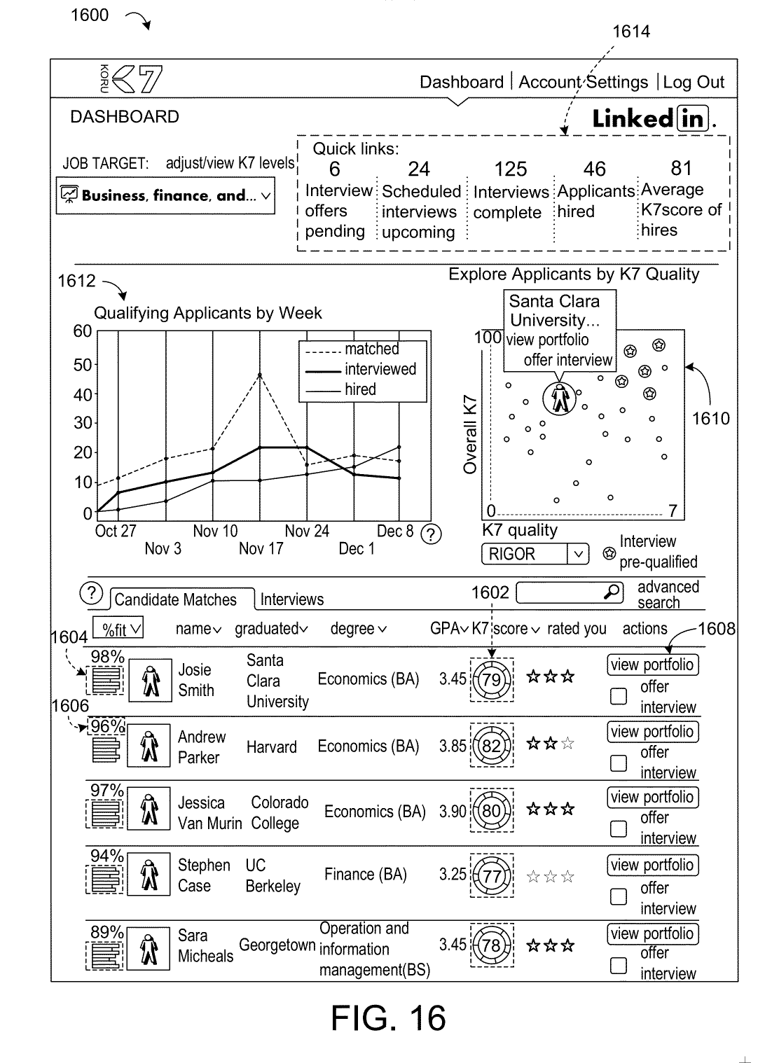

Block 1910 illustrates presenting a user interface that is personalized for a recruiter and/or employer. If the user 106 is a recruiter and/or employer, the presentation module 124 may cause a user interface such as user interface 1600 that is illustrated in FIG. 16 to be presented. FIG. 16 illustrates an example user interface 1600 that provides functionality to present and summarize information related to candidate job seekers. In some examples, a predetermined number of candidate job seekers may be presented via the user interface 1600. The predetermined number of candidate job seekers that are presented via the user interface 1600 may be determined based on a number of candidate job seekers requested (e.g., ordered, purchased, etc.) by a recruiter and/or employer. In other examples, a number of candidate job seekers with competence scores above a predetermined threshold may be presented via the user interface 1600, a number corresponding to a predetermined percentage of job seekers who applied for an employment opportunity may be presented via the user interface 1600, etc.

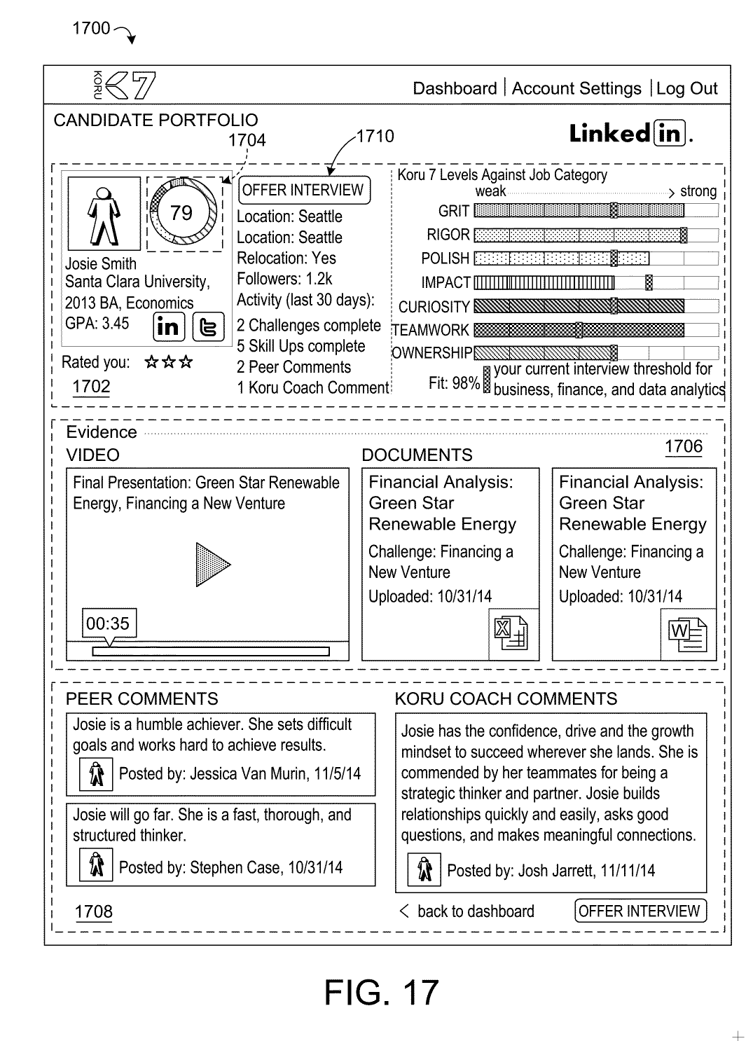

In at least one example, the user interface 1600 may include a graphical comparison between a job seeker's competence score and scores with respect to each of the skills in the skill set and a threshold score and individual threshold scores in the context of a target role associated with a recruiter. The user interface 1600 may present the job seekers that match the recruiter's and/or employer's predetermined criteria and information relevant to the matches, such as the job seeker's competence score as shown in box 1602, competence in each of the skills of the skill set as in box 1604, how well the job seeker's scores with respect to each of the skills matches the recruiter's and/or employer's predetermined criteria (e.g., “% fit” as in box 1606), how the job seeker compares to other job seekers, etc. The recruiter and/or employer may select a job seeker by interacting with the user interface 1600 (e.g., by actuating a “view portfolio” control 1608, for example) and the presentation module 124 may cause additional information, such as work product completed in the projects, peer feedback, mentor (e.g., coach) feedback, etc., as illustrated in FIG. 17, to be presented to the user 106. The user interface 1600 may further include one or more graphical presentations of the determined competency of the job seeker, such as graphs 1610 and 1612. In graph 1610, the presentation module 124 may plot job seekers on a scatter plot based at least in part on their competence score and scores corresponding to the one or more individual skills. A recruiter and/or employer may select one of the points on the scatter plot to learn more about a job seeker that corresponds with the point. In graph 1612, the presentation module 124 may present a graph that summarizes a number of job seekers that have matched with the recruiter and/or employer, how many were offered pre-interviews and/or interviews, and how many the recruiter and/or employer hired. User interface 1600 may also include quick links to additional information related to interviewing, hiring, and other statistics (e.g., data analytics) as illustrated in box 1614. As non-limiting examples, the additional information may include information about a value associated with a number of job seekers who viewed the employment opportunities, a value associated with a number of job seekers that have started an application for the employment opportunities, a value associated with a number of job seekers who applied for the employment opportunities, a value associated with a number of job seekers who were qualified for the employment opportunities (e.g., based on predetermined criteria determined by the recruiters and/or employers), a value associated with a number of job seekers who were offered pre-interviews and/or interviews, a value associated with a number of job seekers who have accepted pre-interviews and/or interviews, etc. In at least one example, the user interface personalized for the recruiters and/or employers may include a list of suggested interview questions directed to individual skills in the skill set.

FIG. 17 illustrates an example user interface 1700 that that provides functionality to present additional information about a matched candidate job seeker. User interface 1700 may include a region (e.g., box 1702) of the interface that summarizes information about a job seeker, including the job seeker's competence score box 1704, demographic information, completed training activities, scores with respect to each skill in the skill set, etc. Additionally, user interface 1700 may include a region (e.g., box 1706) that may display contents and/or provide access to contents of the job seeker's electronic portfolio, which may include example videos, images, documents, etc. evidencing the job seeker's abilities. User interface 1700 may also include one or more regions (e.g., box 1708) that display comments from peers, coaches, etc. If a recruiter and/or employer decides that it would like to offer the job seeker a pre-interview or an interview, the recruiter and/or employer may actuate a control 1710 or otherwise interact with the user interface 1700 to invite the job seeker to an interview.

In some examples, the service provider 102 may invite job seekers to pre-interview for an employment opportunity associated with a recruiter and/or employer. The invitation may be based at least in part on the competence score and/or scores with respect to each skill in the skill set meeting or exceeding the predetermined criteria associated with the employment opportunity. A pre-interview may enable a job seeker to supplement his or her user profile with information specific to an employment opportunity, recruiter, and/or employer and/or complete training activities to earn interview spots. As a non-limiting example, the presentation module 124 may generate a personalized user interface to be presented to the job seeker that includes functionality for the job seeker to access and/or generate a video introduction, writing sample explaining why the job seeker is a good fit for the employment opportunity, recruiter, and/or employer, what the job seeker is most passionate about, etc. In at least one example, the data items accessed and/or generated in association with the invitation for a pre-interview (e.g., video, writing samples, etc.) may be scored (e.g., manually, automatically, etc.) and the scores may be used to positively or negatively adjust the job seeker's competence score and/or scores with respect to individual skills in the skill set.

In at least one example, the recruiter and/or employer may offer a job seeker a meeting (e.g., interview, in-person meeting, virtual meeting, etc.) via an interaction (e.g., actuating a control 1710 on the user interface, etc.) with the user interface (e.g., 1600 and 1700). In additional or alternative environments, a recruiter and/or employer may set a predetermined criteria for competence scores and/or scores with respect to the individual skills of the skill set for a particular employment opportunity. The recruiter and/or employer may initiate a search for one or more job seekers. The matching module 122 may identify one or more job seekers with competence scores and scores corresponding to the individual skills of the skill set that satisfy the predetermined criteria and may facilitate scheduling meetings with such candidates. That is, in at least some examples, recruiters and/or employers may schedule meetings via a single interaction with a device 108.

In at least some examples, based at least in part on the matching module 122 determining that a job seeker's qualifications (e.g., competence score, geographic location, etc.) meet or exceed predetermined criteria associated with the recruiters and/or employers, the matching module 122 may automatically present information about the recruiter and/or employer to the job seeker (via a user profile in the user interface, etc.) and/or information about the job seeker to the recruiter and/or employer. Based at least in part on the matching module 122 determining that the job seeker's qualifications satisfy the recruiter's and/or employer's threshold score, the matching module 122 may provide information about one or more job seekers to the recruiter and/or employer for further examination. The matching module 122 may present the information about one or more job seekers via message, email, push notification, etc. The recruiter and/or employer may access the job seeker's profile to learn additional information about the job seeker, observe evidence of the job seeker's skills (e.g., via access to the job seeker's electronic portfolio), etc.

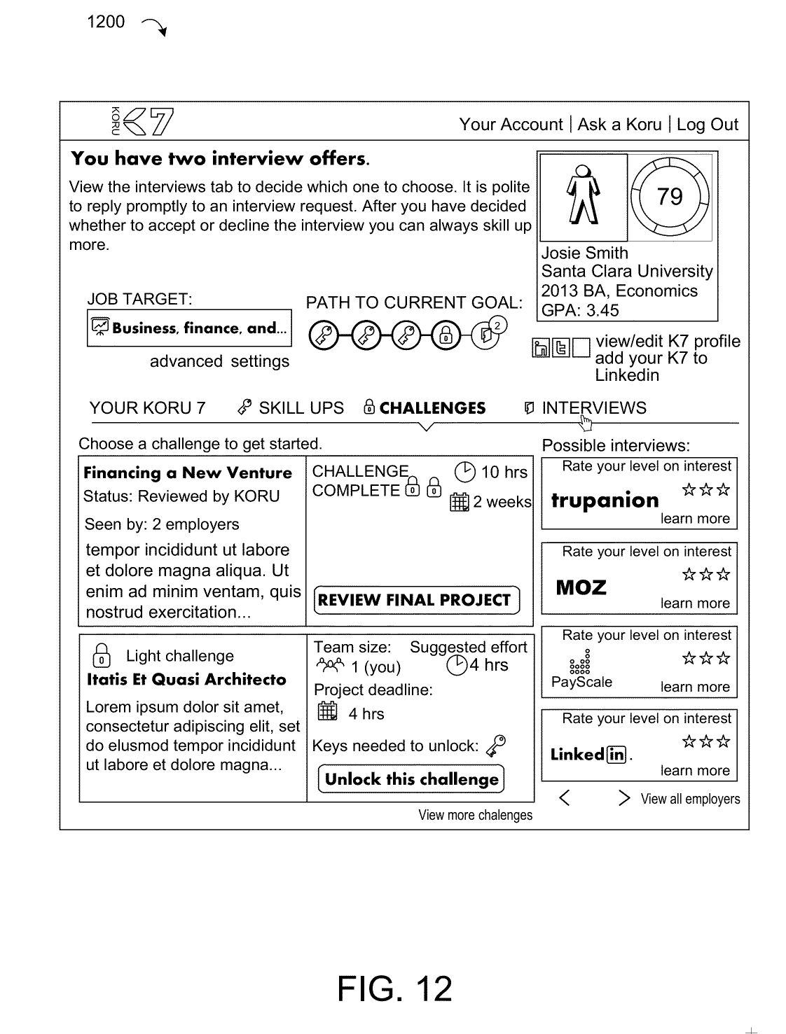

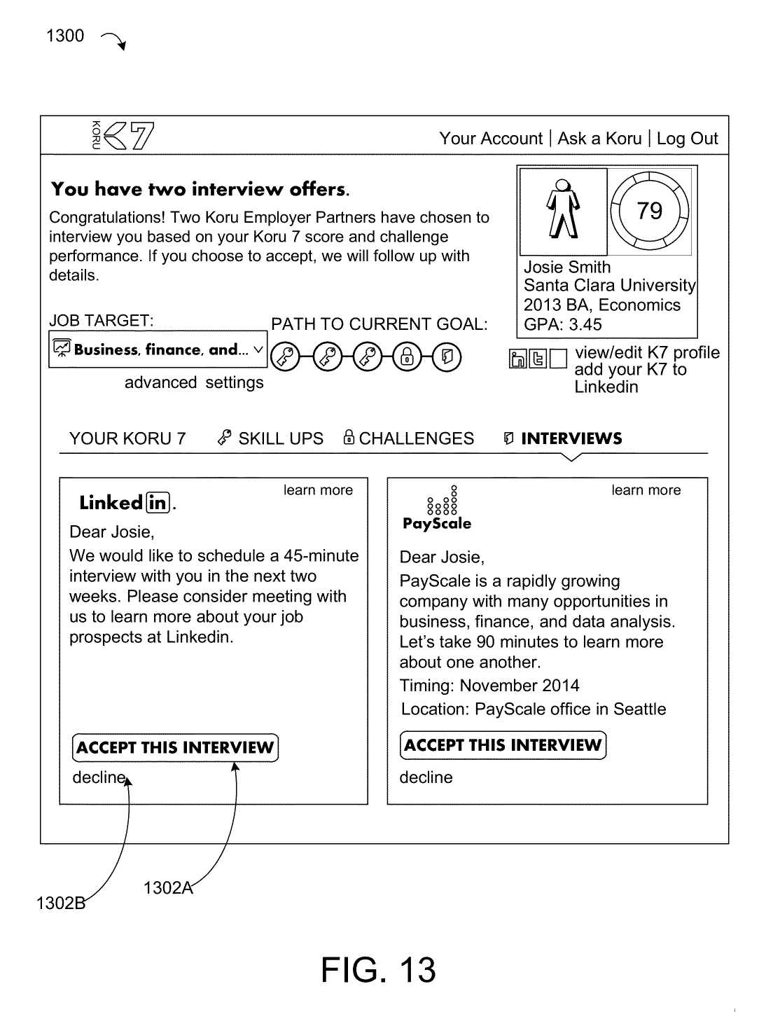

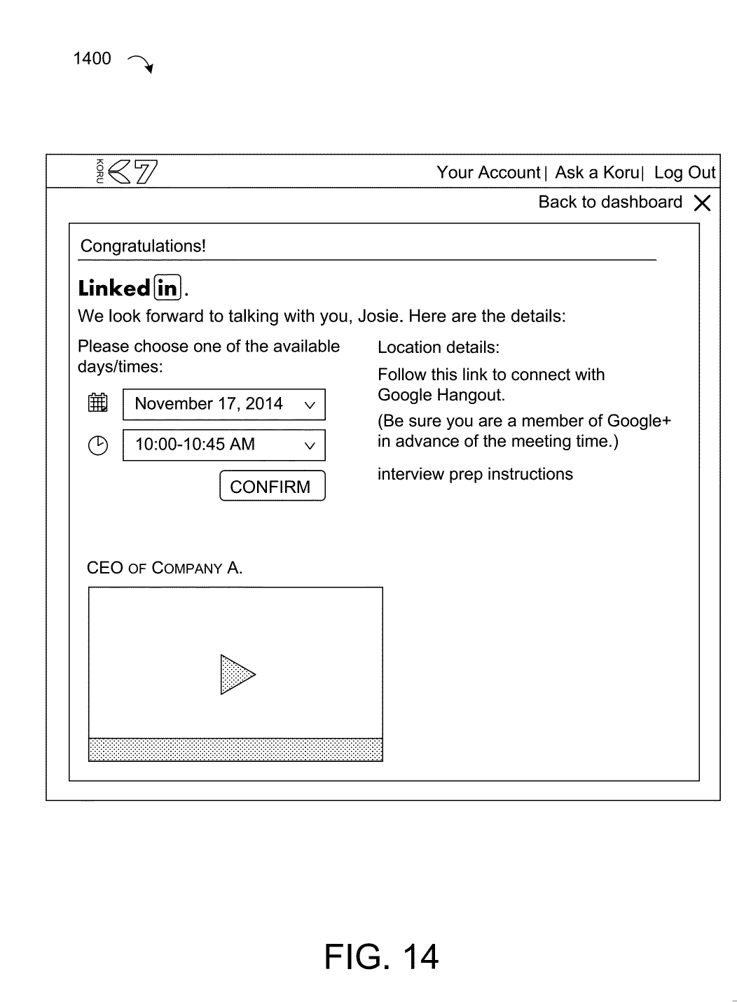

Block 1912 illustrates presenting a job seeker user interface. If the user 106 is a job seeker, the presentation module 124 may generate and cause alternative user interfaces personalized for a job seeker to be presented to the job seeker, as illustrated in FIGS. 12-14. FIG. 12 illustrates an example user interface 1200 that that provides a job seeker with functionality to view one or more interview invitations. User interface 1200 may indicate whether a job seeker has received any pre-interview and/or meeting offers (e.g., interviews), how many pre-interviews and/or meeting offers the job seeker has received, details relevant to any pre-interview and/or meeting offers, etc. FIG. 13 illustrates an example user interface 1300 that that provides a job seeker with functionality to accept one or more interviews. In FIG. 13, LinkedIn and PayScale have offered the job seeker interviews. User interface 1300 may provide the job seeker with the functionality to accept or decline the interview invitation via interaction with the user interface 1300. As a non-limiting example, the job seeker may actuate a control (e.g., 1302A, 1302B, etc.) on the user interface 1300 associated with the job seeker's selection. FIG. 14 illustrates an example user interface 1400 that provides a job seeker with functionality to schedule an interview between the job seeker and a recruiter and/or employer. User interface 1400 may include additional information such as information that may be useful to the job seeker for preparing for the interview, information about the recruiter and/or employer, etc.

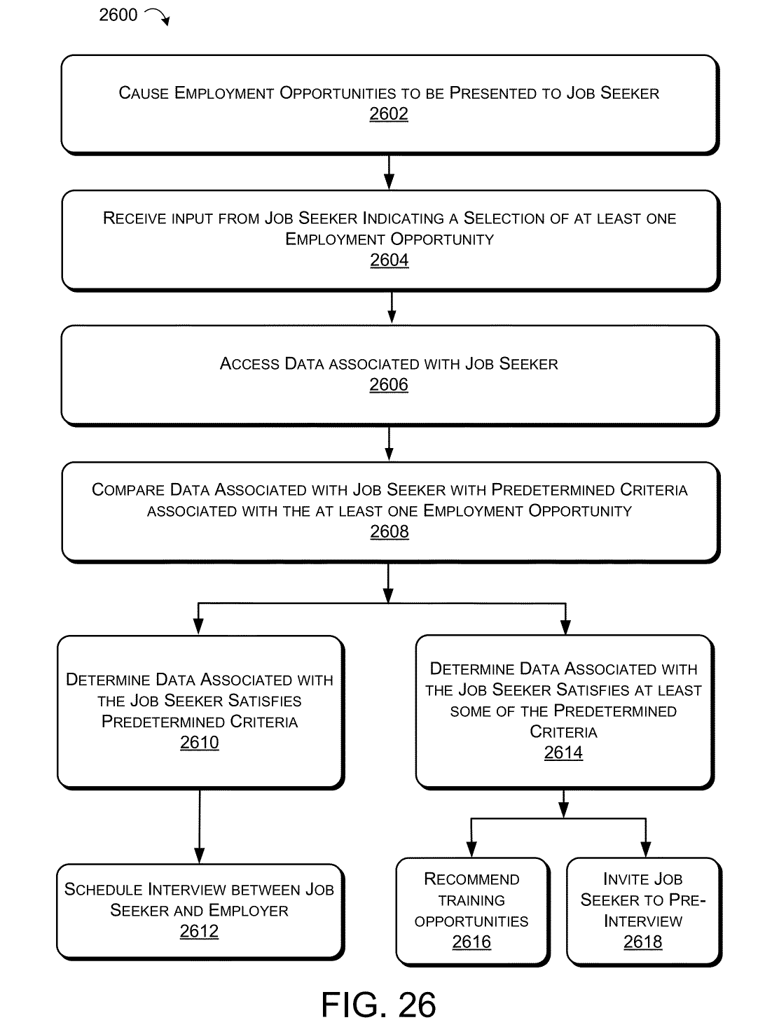

FIG. 26 illustrates an example process 2600 for leveraging a job seeker's determined competence score for determining whether to offer the job seeker an interview for an employment opportunity.

Block 2602 illustrates causing employment opportunities to be presented to the job seeker. The presentation module 124 may generate user interfaces configured to present one or more employment opportunities to the job seekers. In some examples, the user interfaces may present graphical representations corresponding to each of the one or more employment opportunities. The user interfaces may provide functionality for the job seekers to review information associated with each of the one or more employment opportunities and/or predetermined criteria associated with each of the one or more employment opportunities, indicate whether the job seeker is interested in applying for individual of the one or more employment opportunities, etc.

Block 2604 illustrates receiving input from a job seeker indicating a selection of at least one employment opportunity. In at least one example, the job seeker may interact with the user interfaces that are configured to present one or more employment opportunities to the job seekers. In some examples, the job seeker may interact with graphical representations corresponding to the one or more employment opportunities via input peripheral devices (e.g., a keyboard, a mouse, a pen, a game controller, a voice input device, a touch input device, gestural input device, cameras, sensors, and the like), touch input, etc. In at least one example, a job seeker may interact with the user interface in a first manner and/or perform a first gesture to indicate that a job seeker is interested in applying for an employment opportunity and the job seeker may interact with the user interface in a second manner and/or perform a second gesture to indicate that a job seeker is not interested in applying for an employment opportunity. In other examples, a job seeker may actuate a control corresponding to his or her preference on the user interface.

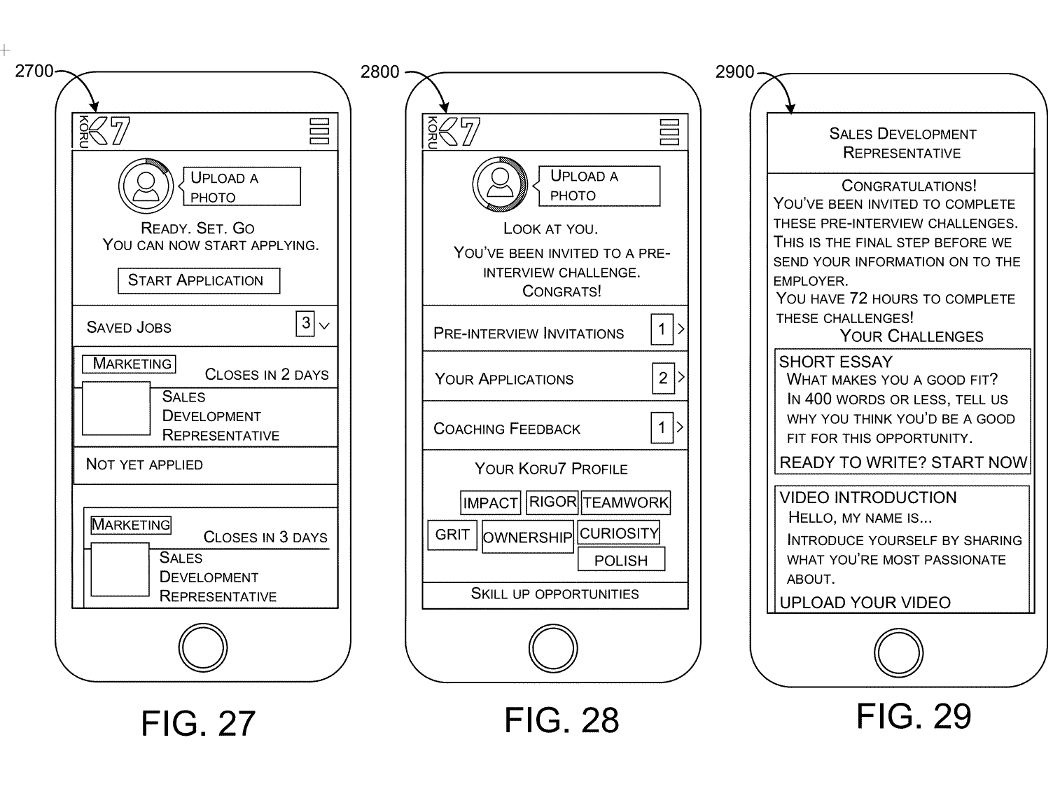

In at least one example, a job seeker may indicate that he or she would like to apply for one or more of the employment opportunities. In some examples, a job seeker can actuate a control on the user interface to begin an application that is applicable to each of the one or more employment opportunities. FIG. 27 illustrates a user interface 2700 that provides functionality for a job seeker to begin an application for one or more employment opportunities. As a non-limiting example, a job seeker may actuate control 2702 to begin the application for each of the employment opportunities selected by the job seeker.

Block 2606 illustrates accessing data and/or data items associated with a job seeker. The matching module 122 may access the data and/or data items stored in the information module 116, database 126, cloud storage, and/or other data repository corresponding to the job seeker. The data may include the job seeker's competence score and/or scores corresponding to each of the skills in the skill set as determined by the diagnostic assessment or updated after completion of one or more exercises. The data items may include examples of completed projects that are stored in an electronic portfolio associated with a user profile corresponding to the job seeker and data associated with other relevant information about the job seeker as described above.

Block 2608 illustrates comparing the data associated with the job seeker with data associated with predetermined criteria associated with the at least one employment opportunity. The matching module 122 may compare data associated with the job seeker with predetermined criteria associated with the at least one employment opportunity. In at least one example, the matching module 122 may compare the competence score and/or scores with respect to individual skills of the skill set may with threshold competence scores and/or threshold scores with respect to individual skills of the skill set associated with the at least one employment opportunity.

Block 2610 illustrates determining that the data associated with the job seeker satisfies the predetermined criteria associated with the at least one employment opportunity. In at least one example, recruiters and/or employers may set minimum thresholds for competence scores and/or scores with respect to the individual skills of the skill set for a particular employment opportunity. The matching module 122 may determine that the competence score and scores corresponding to the individual skills of the skill set associated with the job seeker are above the minimum thresholds and may facilitate scheduling interviews with such candidates. In additional or alternative examples, the matching module 122 may compare the data associated with the job seeker and determine that the job seeker satisfies other predetermined criteria associated with the employment opportunity (e.g., schedule flexibility, U.S. citizenship, etc.). Block 2612 illustrates scheduling an interview between the job seeker and the employer associated with the at least one employment opportunity, based at least in part on determining that the data associated with the job seeker satisfies the predetermined criteria associated with the at least one employment opportunity.

Block 2614 illustrates determining that the data associated with the job seeker satisfies at least some of the predetermined criteria associated with the at least one employment opportunity. In at least one example, recruiters and/or employers may set minimum thresholds for competence scores and/or scores with respect to the individual skills of the skill set for a particular employment opportunity. The matching module 122 may determine that one or more of the competence score and/or scores corresponding to the individual skills of the skill set associated with the job seeker are below the minimum threshold. In additional or alternative examples, the matching module 122 may compare the data associated with the job seeker and determine that the job seeker satisfies some of the other predetermined criteria associated with the employment opportunity (e.g., schedule flexibility, U.S. citizenship, etc.) but does not satisfy other predetermined criteria. Block 2616 illustrates recommending training activities to the job seeker, as described above.

Block 2618 illustrates inviting the job seeker to pre-interview for the employment opportunity. FIG. 28 illustrates an example of a user interface 2800 that may be presented to a job seeker notifying the job seeker that he or she has been invited to a pre-interview. A pre-interview, as described above, may enable a job seeker to supplement his or her user profile with information specific to an employment opportunity, recruiter, and/or employer and/or complete training activities to earn interview spots. As a non-limiting example, the presentation module 124 may generate a personalized user interface to be presented to the job seeker that includes functionality for the job seeker to access and/or generate a video introduction, writing sample explaining why the job seeker is a good fit for the employment opportunity, recruiter, and/or employer, what the job seeker is most passionate about, etc. FIG. 29 illustrates a user interface 2900 configured to provide functionality for the job seeker to access and/or generate a video introduction, writing sample explaining why the job seeker is a good fit for the employment opportunity, recruiter, and/or employer, what the job seeker is most passionate about, etc. As described above, in at least one example, the data items associated accessed and/or generated in association with the invitation for a pre-interview (e.g., video, writing samples, etc.) may be scored (e.g., manually, automatically, etc.) and the scores may be used to positively or negatively adjust the job seeker's competence score and/or scores with respect to individual skills in the skill set.

As described above, the presentation module 124 may generate and cause to be presented one or more provide various functionalities to summarize information associated with job seekers, employers, recruiters, universities or other educational institutions, parents and/or guardians, etc. and/or enable job seekers, employers, recruiters, universities or other educational institutions, parents and/or guardians, etc. to interact with one another and/or the service provider. Various, non-limiting examples of graphical user interfaces are shown in FIGS. 2-17, 21-23, and 27-30. User interfaces personalized for job seekers and employers and/or recruiters are described above. In addition to generating user interfaces that are personalized for job seekers and employers and/or recruiters, the presentation module 124 may generate user interfaces personalized for universities or other educational institutions.

As described above, universities or other educational institutions may also utilize the training, tracking, and placement system to determine where job seekers are applying (e.g., by region, by city, by employer, by industry sector, etc.), progress of the job seekers with respect to the application process, a number of interviews offered to the job seekers, etc. Additionally and/or alternatively, universities or other educational institutions may also utilize aggregated data collected by the training, tracking, and placement system to determine strengths and/or weaknesses with respect to course offerings, extracurricular offerings, programming, etc.

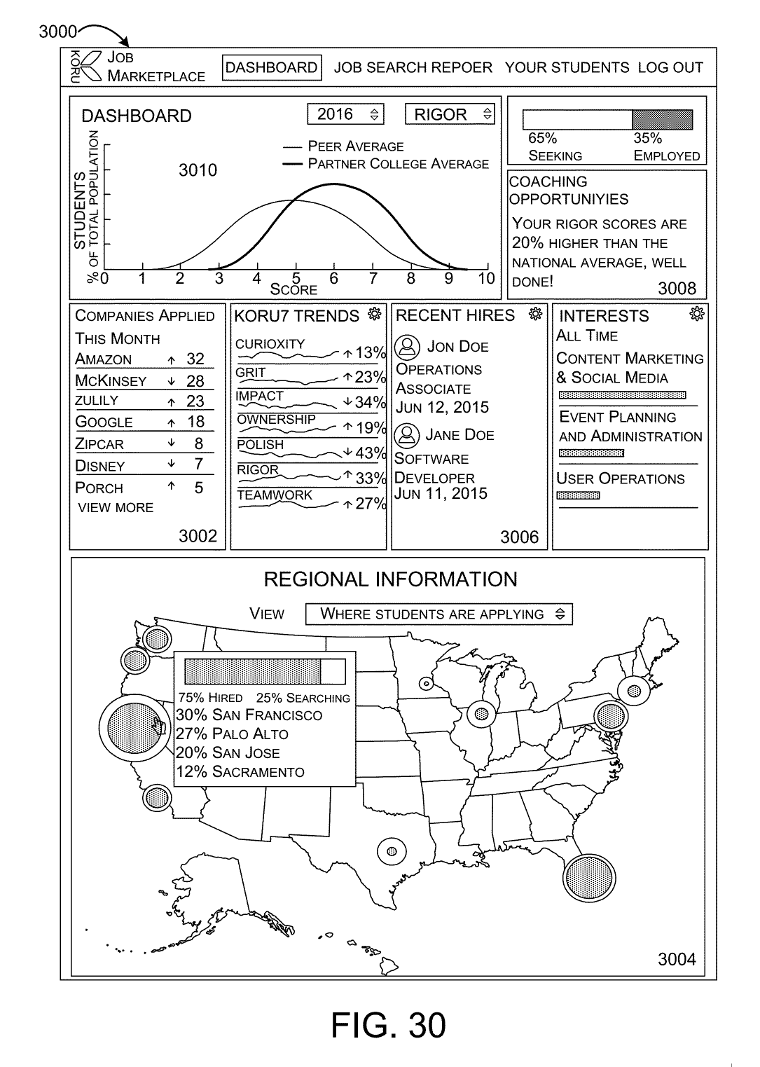

FIG. 30 illustrates an example user interface 3000 that may be presented to universities or other educational institutions to provide functionality for the universities or other educational institutions to view graphical representations of aggregated data associated with job seekers who are associated with the universities or other educational institutions. As illustrated in user interface 3000, universities or other educational institutions may determine companies where job seekers who are associated with the universities or other educational institutions have applied (e.g., box 3002), geographic locations where job seekers who are associated with the universities or other educational institutions have applied (e.g., box 3004), which job seekers have been hired (e.g., box 3006), interests of the job seekers corresponding to industry sectors, roles, and/or employment opportunities, coaching activities (e.g., box 3008), etc. User interface 3000 may include graphical representations providing universities or other educational institutions the ability to determine how job seekers who are associated with the universities or other educational institutions compare to job seekers at other universities or other educational institutions with respect to competence scores and/or scores with respect to individual skills of the skill set (e.g., box 3010).

### CONCLUSION

In closing, although the various examples have been described in language specific to structural features and/or methodical acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
accessing a set of scores associated with a user, individual scores of the set of scores representing a competency of the user with respect to performing individual skills in a skill set;
accessing a set of threshold scores to be considered for a target role or a target employer that uses the one or more skills in the skill set;
comparing the set of scores associated with the user with the set of threshold scores;
based at least in part on the comparing, recommending one or more training activities to assist the user in improving one or more of the individual skills corresponding to the target role or the target employer;
determining that the user completes at least some of the one or more training activities; and
based at least in part on a determination that the user completes the one or more training activities, updating at least one of the individual scores associated with the user.

2. The method as claim 1 recites, wherein the comparing the set of scores associated with the user with the set of threshold scores comprises:
comparing each of the individual scores with respective individual threshold scores of the set of threshold scores;
determining that an individual score of the individual scores is less than a respective individual threshold score of the individual threshold scores;
identifying at least one skill in the skill set corresponding to the individual score that is less than the respective individual threshold score; and
recommending a training activity of the one or more training activities to assist the user in improving the at least one skill.

3. The method as claim 1 recites, further comprising:
determining a first score based at least in part on the set of scores, the first score representative of a competency of the user with respect to the skill set; and
determining a second score based at least in part on the set of threshold scores, the second score indicative of the first score the user should achieve to be considered for the target role or the target employer.

4. The method as claim 3 recites, wherein determining the first score is based at least in part on:
assigning a baseline score to each of the individual scores;
receiving input from the user associated with one or more questions associated with a diagnostic assessment;
adjusting the baseline score for one or more of the individual scores based at least in part on receiving the input from the user; and
computing the first score based on adjusted baseline scores.

5. The method as claim 4 recites, wherein adjusting the baseline score for each of the individual scores is further based at least in part on data corresponding to one or more of data associated with demographics of the user, data associated with a resume of the user, data accessed from social media accounts, retail purchase accounts, or online banking accounts associated with the user, or geolocation devices.

6. The method as claim 3 recites, further comprising:
based at least in part on updating the at least one of the individual scores, updating the first score;
comparing the first score and the second score;
determining that the first score at least equals the second score; and
based at least in part on determining that the first score at least equals the second score, recommending the user to the target employer.

7. The method as claim 1 recites, further comprising:
based at least in part on updating the at least one of the individual scores, comparing the individual scores with respective individual threshold scores of the set of threshold scores; and
determining that each of the individual scores at least equals each of the respective individual threshold scores.

8. The method as claim 7 recites, further comprising, based at least in part on determining that each of the individual scores at least equals each of the respective individual threshold scores, scheduling an interview between the user and the target employer.

9. A system comprising:
one or more processors; and
computer-readable media storing one or more modules that are executable by the one or more processors to perform operations comprising:
receiving predetermined criteria for an employment opportunity from an employer, the predetermined criteria including a threshold score associated with a skill set;
accessing data associated with a plurality of job seekers, the data including a plurality of scores representing competencies of the plurality of job seekers with respect to performing individual skills of the skill set;
determining that a score of the plurality of scores associated with a job seeker of the plurality of job seekers is at least equal to the threshold score; and
based at least in part on determining that the score associated with the job seeker is at least equal to the threshold score, generating one or more personalized user interfaces to be presented to at least one of the job seeker or the employer.

10. The system as claim 9 recites, wherein at least one of the one or more user interfaces includes a graphical comparison between the score and a set of scores used to determine the score and the threshold score and a set of threshold scores used to determine the threshold score in the context of a target role associated with the employer.

11. The system as claim 9 recites, wherein at least one of the one or more user interfaces includes content that visually summarizes information associated with the job seeker and compares the job seeker with others of the plurality of job seekers in the context of a target role associated with the employer.

12. The system as claim 9 recites, wherein at least one of the one or more user interfaces includes the score associated with the job seeker, one or more data items representative of work product completed by the job seeker, and comments about the job seeker.

13. The system as claim 9 recites, wherein at least one of the one or more user interfaces facilitates scheduling an interview between the employer and the job seeker by actuating a control on the at least one of the one or more user interfaces.

14. One or more computer-readable media encoded with instructions that, when executed by a processor, configure a computer to:
access user information associated with a user, the user information including scores, wherein individual of the scores represent a competency of the user with respect to performing individual skills in a skill set;
access threshold scores associated with one or more employers, wherein individual of the threshold scores indicate minimum scores the user should achieve with respect to performing the individual skills to be considered by the one or more employers;
compare the scores with the threshold scores; and
based at least in part on comparing the scores with the threshold scores, recommend one or more training activities to assist the user in improving one or more of the individual skills in the skill set.

15. The one or more computer-readable media of claim 14, wherein the instructions further configure a computer to determine the one or more employers based at least in part on preferences and personality traits of the user.

16. The one or more computer-readable media of claim 14, wherein the instructions further configure a computer to:
determine one or more roles associated with the one or more employers based at least in part on preferences and qualifications of the user;
access additional threshold scores associated with the one or more roles, wherein the additional threshold scores represent minimum scores the user should achieve with respect to performing the individual skills to be considered for the one or more roles;
compare the scores with the additional threshold scores; and
based at least in part on comparing the scores with the additional threshold scores, recommend one or more additional training activities to assist the user in improving one or more of the individual skills in the skill set.

17. The one or more computer-readable media of claim 14, wherein the one or more training activities include in-person training activities and online training activities.

18. The one or more computer-readable media of claim 14, wherein the instructions further configure the computer to:
determine the user completes at least some of the one or more training activities; and
increase at least one of the individual of the scores associated with the user.

19. The one or more computer-readable media of claim 18, wherein the instructions further configure the computer to:
based at least in part on increasing the at least one of the individual of the scores, compare the scores and the threshold scores;
determine that each of the individual of the scores are at least equal to respective of the individual threshold scores; and
schedule an interview between the user and the one or more employers.

20. The one or more computer-readable media of claim 18, wherein, based at least in part on increasing the at least one of the individual scores, the instructions further configure the computer to:
determine a first score based at least in part on the scores, the first score representative of a competency of the user with respect to the skill set; and
determining a second score based at least in part on the threshold scores, the second score indicative of the first score the user should achieve with respect to performing the individual skills to be considered by the one or more employers;
compare the first score and the second score;
determine the first score at least equals the second score;
determine that at least one of the individual of the scores is less than a respective of the individual threshold scores; and
recommend the user to the one or more employers.
